(19) United States
(12) Patent Application Publication
(10) Pub. No.: US 2006/0188768 A1
(43) Pub. Date: Aug. 24, 2006

(54) Membrane-electrode assembly for use in solid polymer electrolyte fuel cell and solid polymer electrolyte fuel cell

(75) Inventors: Nagayuki Kanaoka, Wako-shi (JP); Masaru Iguchi, Wako-shi (JP); Hiroshi Sohma, Wako-shi (JP)

Correspondence Address: ARENT FOX PLLC, 1050 CONNECTICUT AVENUE, N.W., SUITE 400, WASHINGTON, DC, 20036, US

(73) Assignee: HONDA MOTOR CO., LTD.

(21) Appl. No.: 11/331,118

(22) Filed: Jan. 13, 2006

(30) Foreign Application Priority Data
Feb. 18, 2005 (JP) 2005-42969

(51) Int. Cl. H01M 8/10; H01M 4/92

(52) U.S. Cl. 429/33; 429/42

(57) ABSTRACT

The present invention provides a membrane-electrode assembly excellent in electric power generation performance and durability for use in a solid polymer electrolyte fuel cell and a solid polymer electrolyte fuel cell formed therefrom. The membrane-electrode assembly for use in a solid polymer electrolyte fuel cell has a solid polymer electrolyte membrane 1 sandwiched between a pair of electrodes 2 and 2 each containing a catalyst. The solid polymer electrolyte membrane 1 is formed of a polyarylene polymer including a repeating unit represented by the general formula (1), or a polyarylene copolymer including the repeating unit represented by the general formula (1) and a repeating unit represented by the general formula (2). The solid polymer electrolyte fuel cell includes the membrane-electrode assembly for use in a solid polymer electrolyte fuel cell.

### BACKGROUND OF THE INVENTION

1. Field of the Invention

The present invention relates to a membrane-electrode assembly for use in a solid polymer electrolyte fuel cell and a solid polymer electrolyte fuel cell comprising the membrane-electrode assembly.

2. Description of the Related Art

Oil resources have been depleted, and at the same time, environmental problems including the global warming caused by fossil fuel consumption have been increasingly serious. Accordingly, fuel cells have attracted attention as clean electric power supplies for electric motors not involving the generation of carbon dioxide, and thus have been extensively developed and partially begin to be used practically. When the fuel cells are mounted in automobiles and the like, solid polymer electrolyte fuel cells using solid polymer electrolyte membranes are preferably used because such fuel cells can easily provide high voltage and large electric current.

Known as a membrane-electrode assembly to be used in the solid polymer electrolyte fuel cell is a membrane-electrode assembly which comprises a pair of electrode catalyst layers, a solid polymer electrolyte membrane, capable of conducting ions, sandwiched between both electrode catalyst layers, and diffusion layers laminated respectively on the electrode catalyst layers. Each of the electrode catalyst layers is formed by supporting a catalyst such as platinum on a catalyst carrier such as carbon black and by integrating the supported catalyst into a single piece with an ion conductive polymer binder. The membrane-electrode assembly constitutes the solid polymer electrolyte fuel cell through lamination of separators each doubling as a gas path respectively on the electrode catalyst layers.

In the solid polymer electrolyte fuel cell, one of the electrode catalyst layers is used as a fuel electrode into which reductive gas such as hydrogen or methanol is introduced through the intermediary of the diffusion layer, and the other of the electrode catalyst layers is used as an oxygen electrode into which oxidative gas such as air or oxygen is introduced through the intermediary of the diffusion layer. In this configuration, protons and electrons are generated in the fuel electrode side from the reductive gas by the action of the catalyst contained in the electrode catalyst layer, and the protons migrate to the electrode catalyst layer of the oxygen electrode side through the solid polymer electrolyte membrane. The protons react with the oxidative gas and the electrons introduced into the oxygen electrode to generate water in the electrode catalyst layer of the oxygen electrode side by the action of the catalyst contained in the electrode catalyst layer. Consequently, connection of the fuel electrode and the oxygen electrode with a conductive wire makes it possible to form a circuit to transport the electrons generated in the fuel electrode to the oxygen electrode and to take out electric current.

In the membrane-electrode assembly, a polymer belonging to the so-called cation exchange resin is preferably used as the solid polymer electrolyte membrane. Examples of such a polymer may include, for example, the following organic polymers: sulfonated vinyl polymers such as polystyrene sulfonic acid; perfluoroalkylsulfonic acid polymers and perfluoroalkylcarboxylic acid polymers represented by Nafion (trade name, manufactured by DuPont Corp.); and polymers obtained by introducing sulfonic acid groups or phosphoric acid groups into heat resistant polymers such as polybenzimidazole and polyether ether ketone.

These organic polymers are usually used in the form of film in such a way that by taking advantage of their solvent solubility or thermoplasticity, a conductive membrane can be formed to adhere onto an electrode. However, many of these organic polymers are still insufficient in proton conductivity. In addition, there are problems that many of these organic polymers have low durability, the proton conductivity thereof is decreased at high temperatures of 100° C. or higher, sulfonation decreases the mechanical strength thereof, the moisture dependence thereof is large, and adhesion thereof to an electrode is not sufficiently satisfactory. Further, there is a problem such that owing to the hydrated polymer structure of these organic polymers, the membrane is excessively swollen in the course of the operation of the fuel cell to result in decreased strength and collapse of the shape thereof.

On the other hand, there is known a solid polymer electrolyte made of a sulfonated rigid-rod polyphenylene (see, for example, U.S. Pat. No. 5,403,675). The rigid-rod polyphenylene has as its main component a polymer prepared by reacting a polymer obtained by polymerization of an aromatic compound composed of a phenylene chain with a sulfonating agent to introduce sulfonic acid groups thereinto. The rigid-rod polyphenylene is improved in proton conductivity by increasing the introduced amount of the sulfonic acid groups.

However, there are disadvantages such that the rigid-rod polyphenylene sometimes cannot attain a sufficient proton conductivity depending on the temperature conditions or the humidity conditions, and sometimes cannot attain a sufficient hot-water resistance and a sufficient chemical stability.

### SUMMARY OF THE INVENTION

An object of the present invention is to provide a membrane-electrode assembly excellent in electric power generation performance and durability for use in a solid polymer electrolyte fuel cell through overcoming such disadvantages as described above.

Another object of the present invention is to provide a solid polymer electrolyte fuel cell excellent in electric power generation performance and durability.

For the purpose of achieving these objects, the membrane-electrode assembly for use in a solid polymer electrolyte fuel cell of the present invention is a membrane-electrode assembly for a solid polymer electrolyte fuel cell, comprising a solid polymer electrolyte membrane sandwiched between a pair of electrodes each containing a catalyst, wherein:

the solid polymer electrolyte membrane is formed of a polyarylene polymer comprising a repeating unit represented by the following formula (1); and

the electrodes each comprises catalyst particles with platinum or a platinum alloy supported thereon in a percent loading range from 20 to 80 mass % in relation to the total mass of the catalyst, and an ion-conducting binder in a mass range from 0.1 to 3.0 times the mass of the catalyst particles: 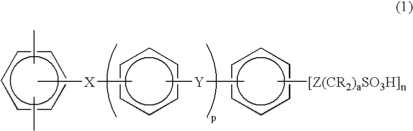
wherein X and Y each represents a divalent organic group or forms together a direct bond; Z represents an oxygen atom or a sulfur atom; R represents at least one atom or group selected from the group consisting of a hydrogen atom, a fluorine atom, an alkyl group and a fluorine-substituted alkyl group; a represents an integer of 1 to 20; n represents an integer of 1 to 5; and p represents an integer of 0 to 10.

The solid polymer electrolyte membrane may be formed of a polyarylene copolymer comprising a first repeating unit represented by the general formula (1) and a second repeating unit represented by the following general formula (2): 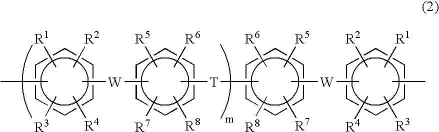
wherein R¹ to R⁸ may be the same or different from each other, and each represents at least one atom or group selected from the group consisting of a hydrogen atom, a fluorine atom, an alkyl group, a fluorine-substituted alkyl group, an allyl group and an aryl group; W represents a divalent electron-withdrawing group; T represents a divalent organic group; and m represents o or a positive integer.

The polyarylene polymer comprises aliphatic sulfonic acid groups, and hence can enhance the ion-exchange capacity and can ensure excellent proton conductivity over a wide temperature range and a wide moisture range. Additionally, the polyarylene polymer comprises the aliphatic sulfonic acid groups at such positions as separated away from the main chain thereof, and hence comprises an excellent hot-water resistance and an excellent chemical stability (particularly, oxidation resistance).

Consequently, the membrane-electrode assembly of the present invention can attain an excellent electric power generation performance and an excellent durability.

Here, it is to be noted that the term “a polyarylene polymer” in the present specification includes a polyarylene copolymers comprising the first repeating unit represented by the general formula (1) and the second repeating unit represented by the general formula (2).

The solid polymer electrolyte fuel cell of the present invention comprises the membrane-electrode assembly. The solid polymer electrolyte fuel cell of the present invention can attain an excellent electric power generation performance and an excellent durability by comprising the membrane-electrode assembly.

### BRIEF DESCRIPTION OF THE DRAWINGS

FIG. 1 is a schematic sectional view illustrating a configuration of a membrane-electrode assembly of the present invention.

### DETAILED DESCRIPTION OF THE PREFERRED EMBODIMENTS

More detailed description will be made below on the embodiment of the present invention with reference to the accompanying drawing.

The membrane-electrode assembly of the present embodiment comprises a solid polymer electrolyte membrane 1, a pair of electrode catalyst layers 2 and 2 sandwiching the solid polymer electrolyte membrane 1, and gas diffusion layers 3 and 3 laminated respectively onto the electrode catalyst layers 2 and 2.

The solid polymer electrolyte membrane 1 is formed of a polyarylene polymer comprising a repeating unit represented by the following general formula (1), or a polyarylene copolymer comprising a first repeating unit represented by the following general formula (1) and a second repeating unit represented by the following general formula (2):

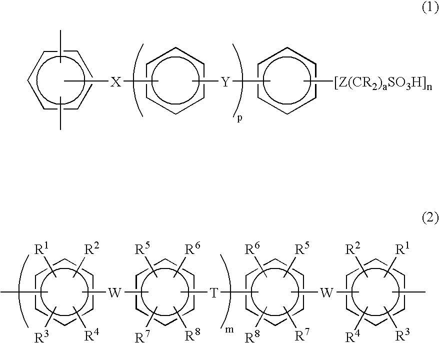

In the general formula (1), X and Y each represents a divalent organic group or forms together a direct bond. Examples of the divalent organic group may include, for example, electron-withdrawing groups such as —CO—, —CONH—, —(CF₂)_{q}— (here, q being an integer of 1 to 10), —C(CF₃)₂—, —COO—, —SO— and —SO₂—; and electron-donating groups such as —O—, —S—, —CH═CH—, —C≡C—, and

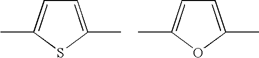

As X, electron-withdrawing groups are preferable because the polymerization activities of these groups are high at the time of preparing the polyarylene polymer, and —CO— and —SO₂— are particularly preferable. On the other hand, Y may or may not be an electron-withdrawing group.

Here, it is to be noted that an electron-withdrawing group as referred to herein means a group for which the Hammett's substituent constant is 0.06 or more for the m-position of the phenyl group and is 0.01 or more for the p-position of the phenyl group.

Z represents an oxygen atom or a sulfur atom.

R represents at least one atom or group selected from the group consisting of a hydrogen atom, a fluorine atom, an alkyl group and a fluorine-substituted alkyl group. Examples of the alkyl group may include a methyl group, an ethyl group, a propyl group, a butyl group, an amyl group and a hexyl group; a methyl group, an ethyl group and the like are preferable. Examples of the fluorine-substituted alkyl group may include a trifluoromethyl group, a perfluoroethyl group, a perfluoropropyl group, a perfluorobutyl group, a perfluoropentyl group and a perfluorohexyl group; a trifluoromethyl group, a pentafluoroethyl group and the like are preferable.

Here, a represents an integer of 1 to 20, n represents an integer of 1 to 5, and p represents an integer of 0 to 10.

In the general formula (2), R¹ to R⁸ may be the same or different from each other, and each represents at least one atom or group selected from the group consisting of a hydrogen atom, a fluorine atom, an alkyl group, a fluorine-substituted alkyl group, an allyl group and an aryl group. Examples of the alkyl group and the fluorine-substituted alkyl group may include the same groups as the alkyl groups and the fluorine-substituted alkyl groups cited to be adopted for R in the general formula (1). Examples of the allyl group may include a propenyl group, and examples of the aryl group may include a phenyl group and a pentafluorophenyl group.

W represents a divalent electron-withdrawing group. Examples of the electron-withdrawing group may include, for example, —CO—, —CONH—, —(CF₂)_{q}— (here, q being an integer of 1 to 10), —C(CF₃)₂—, —COO—, —SO— and —SO₂—.

T represents a divalent organic group, and may be an electron-withdrawing group or an electron-donating group. Examples of the electron-withdrawing group may include the same groups as the groups cited as W. Examples of the electron-donating group may include, for example, —O—, —S—, —CH═CH—, —C≡C—, and

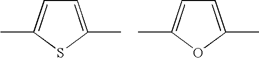

Here, m is 0 or a positive integer, and the upper limit thereof is 100, and preferably 80.

The polyarylene polymer preferably comprises the first repeating unit represented by the general formula (1) in a content of 0.5 to 100 mol %, and the second repeating unit represented by the general formula (2) in a content of 0 to 99.5 mol %.

As the molecular weight of the polyarylene polymer, the weight average molecular weight thereof as measured by gel permeation chromatography (GPC) relative to polystyrene standards is 10,000 to 1,000,000 and preferably 20,000 to 800,000, and the number average molecular weight thereof as measured by GPC relative to polystyrene standards is 5,000 to 200,000, and preferably 10,000 to 160,000. When the weight average molecular weight relative to polystyrene standards is less than 10,000, neither sufficient coating properties nor sufficient strength properties can be obtained in such a way that formed films crack. On the other hand, when the weight average molecular weight relative to polystyrene standards exceeds 1,000,000, there are problems in that the solubility comes to be insufficient, and the solution viscosity becomes high and the workability thereby becomes poor.

The amount of the sulfonic acid groups in the polyarylene polymer is 0.5 to 3 meq/g, and preferably 0.8 to 2.8 meq/g. When the amount concerned is less than 0.5 meq/g, sometimes no sufficient proton conductivity is obtained. On the other hand, when the amount concerned exceeds 3 meq/g, sometimes the hydrophilicity is increased, the polymer concerned turns into a water-soluble or hot water-soluble polymer, or the durability is decreased even if the polymer does not become water-soluble.

The molecular structure of the polyarylene polymer can be verified, for example, on the basis of the infrared absorption spectrum through the S═O absorptions in 1,030 to 1,045 cm⁻¹ and in 1,160 to 1,190 cm⁻¹; the C—O—C absorption in 1,130 to 1,250 cm⁻¹; the C═O absorption in 1,640 to 1,660 cm⁻¹ and the like; the composition ratios thereof can be found on the basis of the neutralization titration of sulfonic acid, the elemental analysis and the like. The molecular structure of the polyarylene polymer can also be verified on the basis of the aromatic proton peaks of 6.8 to 8.0 ppm in the nuclear magnetic resonance spectrum (¹H-NMR) thereof.

The electrode catalyst layers 2 each preferably comprise a supported catalyst in which platinum or a platinum alloy is loaded on a carbon material with well-developed pores. As the carbon material with well-developed micro-porous structure, carbon black, activated carbon and the like can be preferably used. Examples of the carbon black may include channel black, furnace black, thermal black and acetylene black. The activated carbon can be obtained by subjecting various types of carbon atom-containing materials to carbonizing and activating treatment.

Although the supported catalyst may the catalyst in which platinum is loaded on a carbon material, use of a platinum alloy makes it possible to impart the stability and the activity as the electrode catalyst. Preferable as the platinum alloy are alloys composed of platinum and one or more metals selected from the group consisting of platinum group metals other than platinum (ruthenium, rhodium, palladium, osmium and iridium), iron, titanium, gold, silver, chromium, manganese, molybdenum, tungsten, aluminum, silicon, rhenium, zinc and tin; the platinum alloy concerned may contain intermetallic compounds of platinum and the metals to be alloyed with platinum.

The loading of platinum or a platinum alloy in the supported catalyst (the ratio of the mass of platinum or the platinum alloy to the total mass of the supported catalyst) is needed to be set within a range from 20 to 80 mass %, and is particularly preferably to be set within a range from 30 to 55 mass %. When set within these ranges, the use of the membrane-electrode assembly in a fuel cell permits obtaining a high output power. When the loading is less than 20 mass %, there is a fear that a sufficient output power can not be obtained, while when the loading exceeds 80 mass %, there is a fear that platinum particles or particles of a platinum alloy can not be supported on a carbon material to be the carrier in a well dispersed manner.

For the purpose of obtaining highly active gas diffusion electrodes, the primary particle size of platinum or the platinum alloy preferably falls within a range from 1 to 20 nm, and particularly from the view point of reaction activity, preferably falls within a range from 2 to 5 nm because this range ensures a large surface area of platinum or the platinum alloy.

The electrode catalyst layers 2 each contains, in addition to the supported catalyst, an ion-conducting polymer electrolyte having sulfonic acid groups as an ion-conducting binder. Usually, the supported catalyst is coated with the electrolyte concerned, and the protons (H⁺) migrate along the channels formed by the continuity of the electrolyte concerned.

As the ion-conducting polymer electrolyte having sulfonic acid groups, particularly preferably used are perfluorocarbon polymers typified by Nafion (trade name), Flemion (trade name) and Aciplex (trade name). It is to be noted that as the ion-conducting polymer electrolyte having sulfonic acid groups, there may be used an ion-conducting polymer electrolyte dominantly containing aromatic hydrocarbon compounds such as the polyarylene polymers used in the solid polymer electrolyte membrane 1.

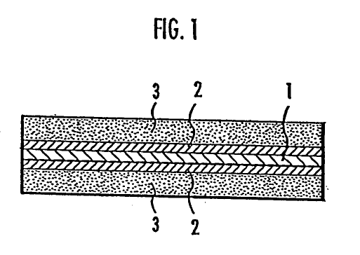

The membrane-electrode assembly shown in FIG. 1 may comprise only an anode catalyst layer (an electrode catalyst layer 2), a proton conductive membrane (a solid polymer electrolyte membrane 1) and a cathode catalyst layer (an electrode catalyst layer 2); however, the membrane-electrode assembly preferably comprises a gas diffusion layer 3 on the outside of the electrode catalyst layer 2 on each of both cathode and anode sides. As the gas diffusion layers 3, layers formed of conductive porous substrate such as carbon paper and carbon cloth. The gas diffusion layers 3 also have a function as current collectors, and accordingly, in the present invention, a combination of a gas diffusion layer 3 and an electrode catalyst layer 2 is to be referred to as an electrode.

In a solid polymer electrolyte fuel cell comprising the membrane-electrode assembly of the present embodiment, an oxygen-containing gas is supplied to the cathode and a hydrogen-containing gas is supplied to the anode. More specifically, for example, separators with grooves formed thereon as the gas flow channels are provided outside both of the gas diffusion layers 3 of the membrane-electrode assembly, and gases to be fuels for the membrane-electrode assembly are supplied by passing the gases along the gas flow channels.

As the method for fabricating the membrane-electrode assembly, various methods including the following methods can be adopted:

i) a method in which a pair of electrode catalyst layers 2 are formed directly on the solid polymer electrolyte membrane 1, and the member thus formed is sandwiched between a pair of gas diffusion layers 3 according to need;

ii) a method in which electrode catalyst layers 2 are formed respectively on two substrates made of carbon paper or the like to be gas diffusion layers 3, and then the members thus formed are bonded to the solid polymer electrolyte 1; and

iii) a method in which electrode catalyst layers 2 each are formed respectively on two flat plates, transferred to the surfaces of a solid polymer electrolyte film 1, then the flat plates are peeled off, and the member thus formed is further sandwiched between a pair of gas diffusion layers 3 according to need.

As the method for fabricating the electrode catalyst layers 2, there may be used methods well known in the art including, for example, a method in which a dispersion liquid is obtained by dispersing the catalyst to be supported and a perfluorocarbon polymer having sulfonic acid groups in a dispersion medium (by adding, according to need, a water repellant, a pore-forming agent, a thickener, a diluting solvent and the like), and the dispersion liquid is used to form the electrode catalyst layers 2 through spraying, coating, screen printing or the like on the solid polymer electrolyte membrane 1, the gas diffusion layers 3 or flat plates. When the electrode catalyst layers 2 are not directly formed on the solid polymer electrolyte membrane 1, the electrode catalyst layers 2 and the solid polymer electrolyte membrane 1 are preferably bonded to each other by means of a hot press method, an adhering method (Japanese Patent Laid-Open No. 7-220741) or the like.

Next, the method for preparing the polyarylene polymer will be described below.

The polyarylene polymer can be prepared by reacting a compound (A) with a compound (B) or a compound (C). In what follows, the compounds (A), (B) and (C) to be used for preparation of the polyarylene polymer will be described one after the other.

Firstly, the compound (A) may be a polymer composed of only a repeating unit represented by the following general formula (3), or may be a copolymer composed of a repeating unit represented by the following general formula (3) and a repeating unit represented by the following general formula (2):

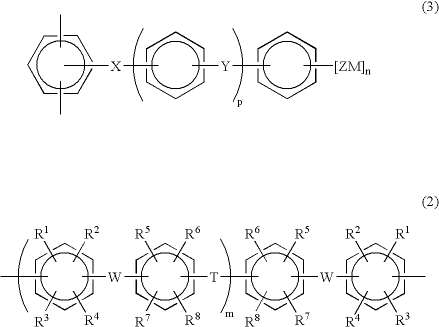

In the general formula (3), X, Y, Z, n and p are the same as in the above described general formula (1), and M represents a hydrogen atom or an alkali metal atom. Examples of the alkali metal atom may include a sodium atom, a potassium atom and a lithium atom.

Secondly, the compound (B) has a structure represented by the following general formula (4):

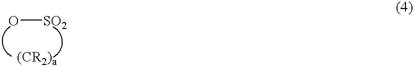

In the general formula (4), R and a are the same as in the general formula (1). Examples of the compound (B) may include, for example, the following compounds: 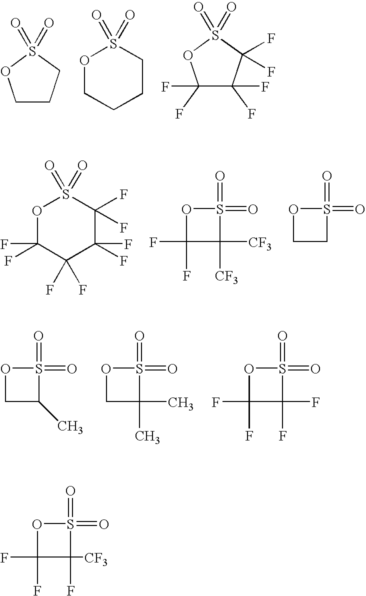
The compound (C) has a structure represented by the following general formula (5):
L-(CR₂)ₐ—SO₃M ( 5)
In the general formula (5), R and a are the same as in the general formula (1), M is the same as in the general formula (3), and L represents a chlorine atom, a bromine atom or an iodine atom. Examples of the compound (C) may include, for example, the following compounds. In the following compounds, any one of K, Li and H may replace Na, and any one of Br and I may replace Cl.
ClCH₂SO₃Na ClCH₂CH₂CH₂SO₃Na
ClCH₂CH₂SO₃Na ClCH₂CH₂CH₂CH₂SO₃Na
ClCF₂SO₃Na ClCF₂CF₂CF₂SO₃Na
ClCF₂CF₂SO₃Na ClCF₂CF₂CF₂CF₂SO₃Na

When the polyarylene polymer is prepared, by controlling the number of the carbon atoms in the compound (B) and the number of the carbon atoms in the compound (C), namely, “a” in the general formulas (4) and (5), the introduction positions and the introduction amount of the sulfonic acid group in the polyarylene polymer to be finally obtained can be controlled.

Next, there will be shown a synthesis example in which by reacting the compound (A) and the compound (B) with each other, the polyarylene polymer having sulfonic acid groups is obtained. The reaction between the compound (A) and the compound (B) can be carried out by dissolving the compound (A) and the compound (B) in a solvent under basic conditions, for example, as shown in the following reaction formula (6):

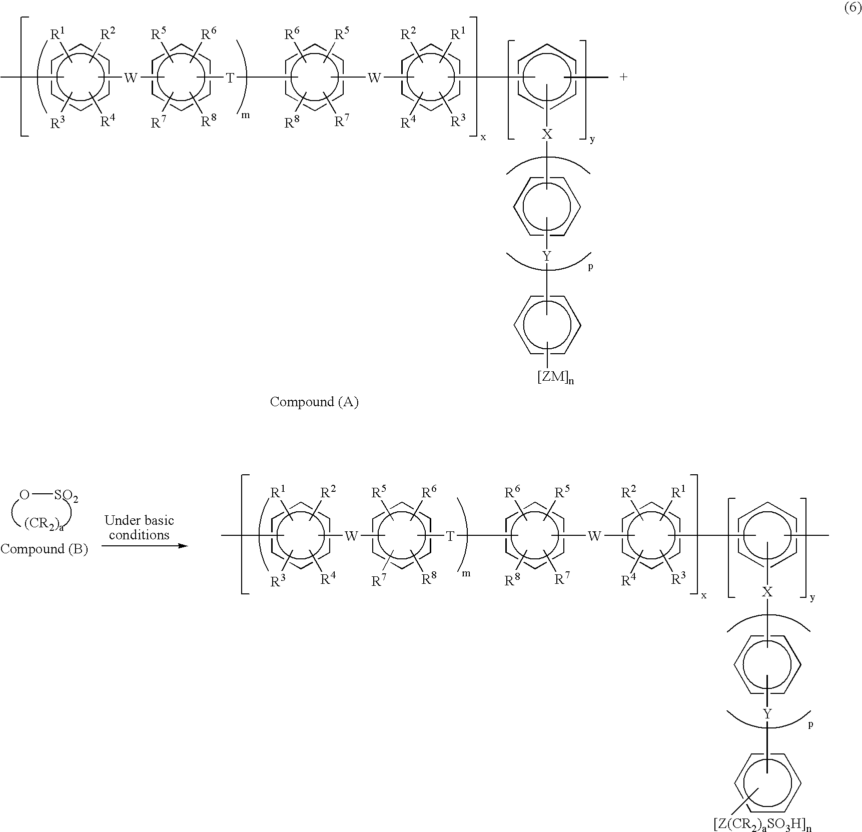

For example, when M in the compound (A) is a hydrogen atom, the compound (A) can be converted into an alkali metal salt by adding an alkali metal, an alkali metal hydride, an alkali metal carbonate or the like according to need in a polar solvent having a high dielectric constant. Examples of the solvent having a high dielectric constant may include N-methyl-2-pyrrolidone, N,N-dimethylacetamide, sulfolane, diphenylsulfone and dimethyl sulfoxide. Examples of the alkali metal may include lithium, sodium and potassium. Examples of the alkali metal hydride, alkali metal hydroxide and alkali metal carbonate may include respectively the hydrides, hydroxides and carbonates of the above described alkali metals.

Usually, a slight excess of the alkali metal is reacted with the sulfonic acid group of the compound (A), namely, in an amount of 1.1 to 4 equivalents and preferably 1.2 to 3 equivalents per equivalent of the sulfonic acid group.

In the reaction between the compound (A) and the compound (B), the oxygen or sulfur atom represented by Z in the compound (A) causes under basic conditions nucleophilic substitution reaction involving the carbon atom next to the oxygen atom in the compound (B) to result in ring opening of the compound (B). A specific example of this reaction is shown in the following reaction formula (7). It is to be noted that the compound (A), the compound (B) and the alkali reagent shown in reaction formula (7) are not limited to these specific examples of the compound (A), the compound (B) and the alkali reagent.

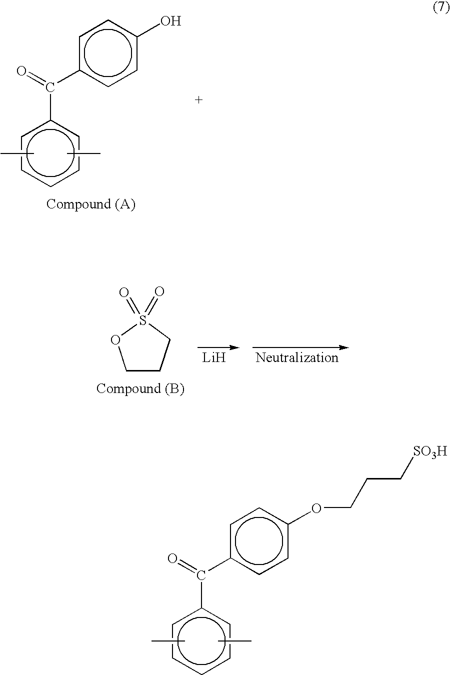

Next, there is shown a synthetic example for obtaining the polyarylene polymer having sulfonic acid groups by reacting the compound (A) and the compound (C) with each other. The reaction between the compound (A) and the compound (C) can be carried out through dissolving the compound (A) and the compound (C) in a solvent under basic conditions, for example, as shown in the following reaction formula (8):

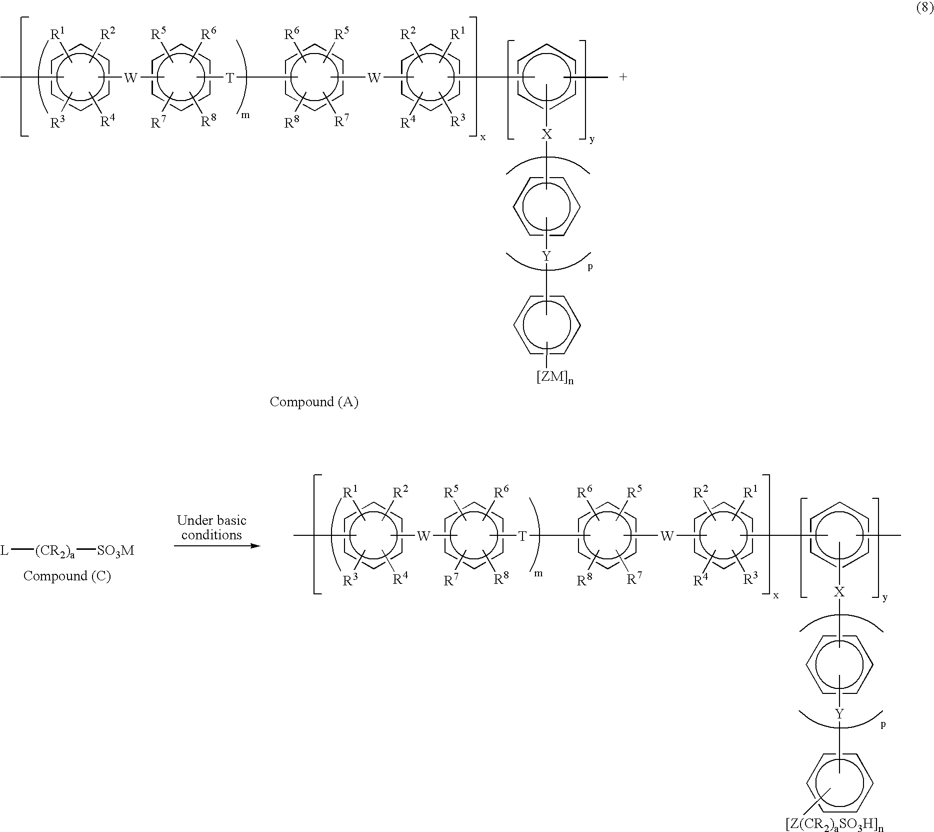

The reaction between the compound (A) and the compound (C) can use, for example, the polar solvent and the alkali reagent shown in the above described reaction between the compound (A) and the compound (B). In the reaction between the compound (A) and the compound (C), the oxygen or sulfur atom represented by Z in the compound (A) causes under basic conditions a nucleophilic substitution reaction involving the carbon atom next to the oxygen atom in the compound (B). A specific example of this reaction is shown in the following reaction formula (9). It is to be noted that the compound (A), the compound (C) and the alkali reagent shown in reaction formula (8) are not limited to these specific examples of the compound (A), the compound (C) and the alkali reagent.

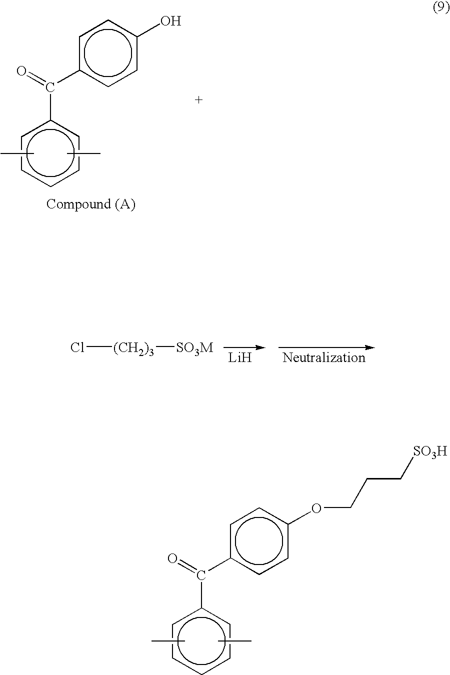

Next, the method for preparing the compound (A) is described. In order to obtain the compound (A), at least one compound (A₁) represented by the following general formula (10) as a monomer is polymerized, or at least one compound (A₁) represented by the general formula (10) as a monomer and another aromatic compound (preferably at least one compound (A₂) represented by the following general formula (11)) as a monomer are copolymerized. Thereafter, the one or more hydrocarbon groups represented by R⁹ in the general formula (10) are eliminated.

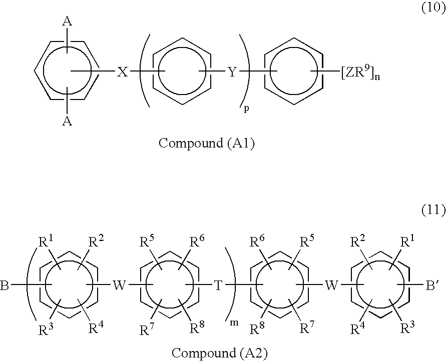

In the general formula (10), X, Y, Z, n and p are the same as in the general formula (1), and A and A′ may be the same or different from each other, and each are a halogen atom (a chlorine, bromine or iodine atom) other than a fluorine atom or a group represented by —OSO₂Q (here, Q representing an alkyl group, a fluorine-substituted alkyl group or an aryl group).

Examples of the alkyl group represented by Q may include a methyl group and an ethyl group; examples of the fluorine-substituted alkyl group may include a trifluoromethyl group; and examples of the aryl group may include a phenyl group and a p-tolyl group.

R⁹ represents a hydrogen atom, or a hydrocarbon group having 1 to 20 carbon atoms. Specific examples of the hydrocarbon group may include chain hydrocarbon groups, branched hydrocarbon groups, alicyclic hydrocarbon groups and hydrocarbon groups each having a five-membered heterocycle, such as a methyl group, an ethyl group, a n-propyl group, an iso-propyl group, a tert-butyl group, an iso-butyl group, a n-butyl group, a sec-butyl group, a neopentyl group, a cyclopentyl group, a hexyl group, a cyclohexyl group, a cyclopentylmethyl group, a cyclohexylmethyl group, an adamantyl group, an adamantylmethyl group, a 2-ethylhexyl group, a bicyclo[2.2.1]heptyl group, a bicyclo[2.2.1]heptylmethyl group, a tetrahydrofurfuryl group, a 2-methylbutyl group and a 3,3-dimethyl-2,4-dioxolanemethyl group.

The hydrocarbon groups may include an oxygen atom, a nitrogen atom or a sulfur atom. Examples of the oxygen atom-containing hydrocarbon group may include, for example, tetrahydro-2-pyranyl group, a methoxymethyl group, an ethoxyethyl group and a propoxymethyl group. Preferred among these groups are a tetrahydro-2-pyranyl group and a methoxymethyl group.

In the general formula (11), R¹ to R⁸, W, T and m are the same as in the general formula (2), and B and B′ may be the same or different from each other and each are a halogen atom other than a fluorine atom or a group represented by —OSO₂Q (here, Q representing an alkyl group, a fluorine-substituted alkyl group or an aryl group). Examples of Q may include the groups cited as examples for the general formula (10).

Next, the compound (A₁) is described.

The compound (A₁) can be synthesized, for example, by means of the method represented by the following reaction formula (12). Here is shown an example in which an aromatic acid halide is used as the starting material (compound (I)), anisole is reacted with this aromatic acid halide to yield a compound (A₁′) which contains a hydroxy group, and the protecting group of this hydroxy group is a tetrahydro-2-pyranyl group. However, the compound (A₁′), the material (the reacting material) to be reacted with the starting material and the protecting group are not limited to these. For example, as the reacting material, usable in place of anisole are 1,4-dimethoxybenzene, 1,3-dimethoxybenzene, 1,2-dimethoxybenzene, 1,2,3-trimethoxybenzene, methylthiobenzene and the like.

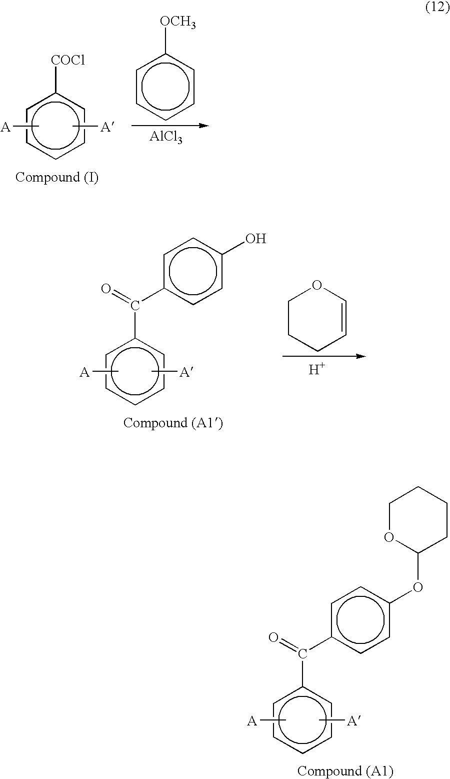

The first step of the method represented by the reaction formula (12) is the Friedel-Crafts acylation of the compound (I). In the Friedel-Crafts acylation, for example, aluminum chloride is added to a dichloromethane solution of anisole under ice bath at −10° C., and thereafter the compound (I) is dropped into the reaction solution, and the reaction solution is stirred at room temperature for 1 to 12 hours. Thereafter, the reaction solution is poured into ice water containing concentrated hydrochloric acid, the separated organic layer was extracted with a 10% aqueous solution of sodium hydroxide and the sodium hydroxide is neutralized with hydrochloric acid to precipitate a solid product, and the solid product is extracted with an organic solvent (for example, ethyl acetate). Then, the extraction solution is concentrated, and recrystallized if necessary, to yield the compound (A₁′) having an acyl group and a hydroxy group. It is to be noted that when methylthiobenzene is used in place of anisole in the first step, the compound (A₁′) having a thiol group can be obtained.

By controlling the substitution positions and the number of the substituents of the hydroxy groups (or the thiol groups) in the aromatic ring of the compound (A₁′), the introduction positions and the introduction amount of the sulfonic acid group in the polyarylene polymer to be finally obtained can be controlled. In other words, in the above described step (the Friedel-Crafts acylation), the introduction positions and the introduction amount of the sulfonic acid group in the polyarylene polymer to be finally obtained can be controlled by using a benzene with an OR or SR group (R representing, for example, a hydrogen atom, or an alkyl group such as a methyl, ethyl, t-butyl group or the like) substituted at a predetermined position thereof.

The second step of the method represented by the reaction formula (12) is the introduction of the protective group for the compound (A₁′). The introduction of the protective group is carried out, for example, as follows: the compound (A₁′) and 2H-dihydropyran in an amount of 1 to 20 times the moles of the compound (A₁′) are dissolved in toluene in the presence of an acid catalyst (for example, a cation exchange resin) and stirred at room temperature for 1 to 24 hours. Then, the acid catalyst is removed, thereafter the toluene solution is concentrated, and recrystallized if necessary, to yield the compound (A₁) in which a tetrahydro-2-pyranyl group is introduced as the protective group into the compound (A₁′). It is to be noted that when methylthiobenzene is used in place of anisole in the first step, the tetrahydro-2-pyranyl group functions as the protective group for the thiol.

Examples of the compound (A₁) represented by the general formula (10) may include the following compounds. The compound (A₁) represented by the general formula (10) may be the compounds in which the chlorine atoms each are substituted with a fluorine or iodine atom in the following compounds, the compounds in which —CO— is substituted with —SO₂— in the following compounds, and the compounds in which the chlorine atoms each is substituted with a fluorine or iodine atom, and —CO— is substituted with —SO₂— in the following compounds.

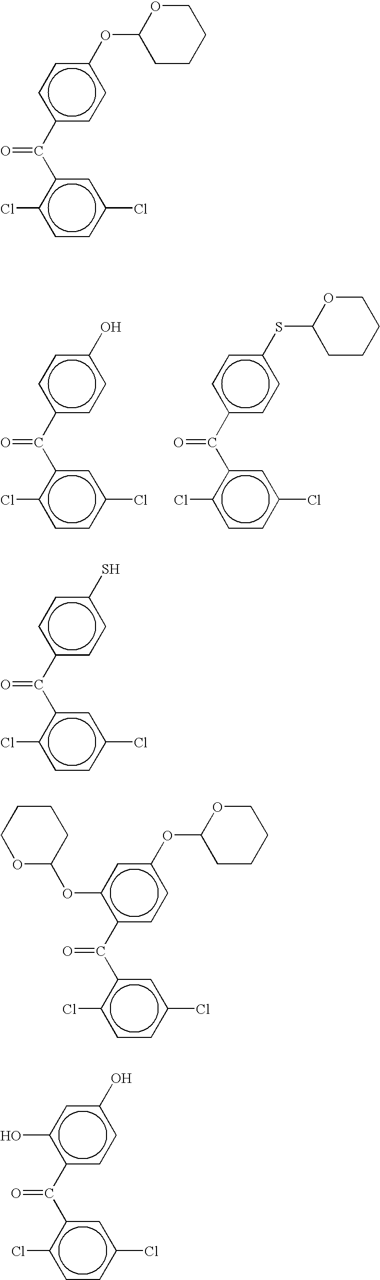

Next, the compound (A₂) is described.

First, examples of the compound (A₂) represented by the general formula (11) with m=0 may include, for example, 4,4′-dichlorobenzophenone, 4,4′-dichlorobenzanilide, bis(chlorophenyl)difluoromethane, 2,2-bis(4-chlorophenyl)hexafluoropropane, 4-chlorophenyl 4-chlorobenzoate, bis(4-chlorophenyl)sulfoxide and bis(4-chlorophenyl)sulfone. The compound (A₂) may be the compounds in which the chlorine atoms each is substituted with a bromine or iodine atom in the above described compounds, and the compounds in which at least one or more of the halogen atoms substituted at the 4-positions of the benzene rings are substituted at the 3-positions in the above described compounds.

Next, examples of the compound (A₂) represented by the general formula (11) with m=1 may include, for example, 4,4′-bis(4-chlorobenzoyl)diphenyl ether, 4,4′-bis(4-chlorobenzoylamino)diphenyl ether, 4,4′-bis(4-chlorophenylsulfonyl)diphenyl ether, 4,4′-bis(4-chlorophenyl)diphenyl ether dicarboxylate, 4,4′-bis[(4-chlorophenyl)-1,1,1,3,3,3-hexafluoropropyl]diphenyl ether, 4,4′-bis[(4-chlorophenyl)1,1,1,3,3,3-hexafluoropropyl]diphenyl ether, and 4,4′-bis[(4-chlorophenyl)tetrafluoroethyl]diphenyl ether. The compound (A₂) may include the compounds in which the chlorine atoms each is substituted with a bromine or iodine atom in the above described compounds, the compounds in which the halogen atoms substituted at the 4-positions of the benzene rings are substituted at the 3-positions in the above described compounds, and the compounds in which at least one or more of the groups substituted at the 4-positions of the diphenyl ethers are substituted at the 3-positions in the above described compounds.

Examples of the compound (A₂) may further include 2,2-bis[4-{4-(4-chlorobenzoyl)phenoxy}phenyl]-1,1,1,3,3,3-hexafluoropropane, bis[4-{4-(4-chlorobenzoyl)phenoxy}phenyl]sulfone, and the compounds represented by the following formulas:

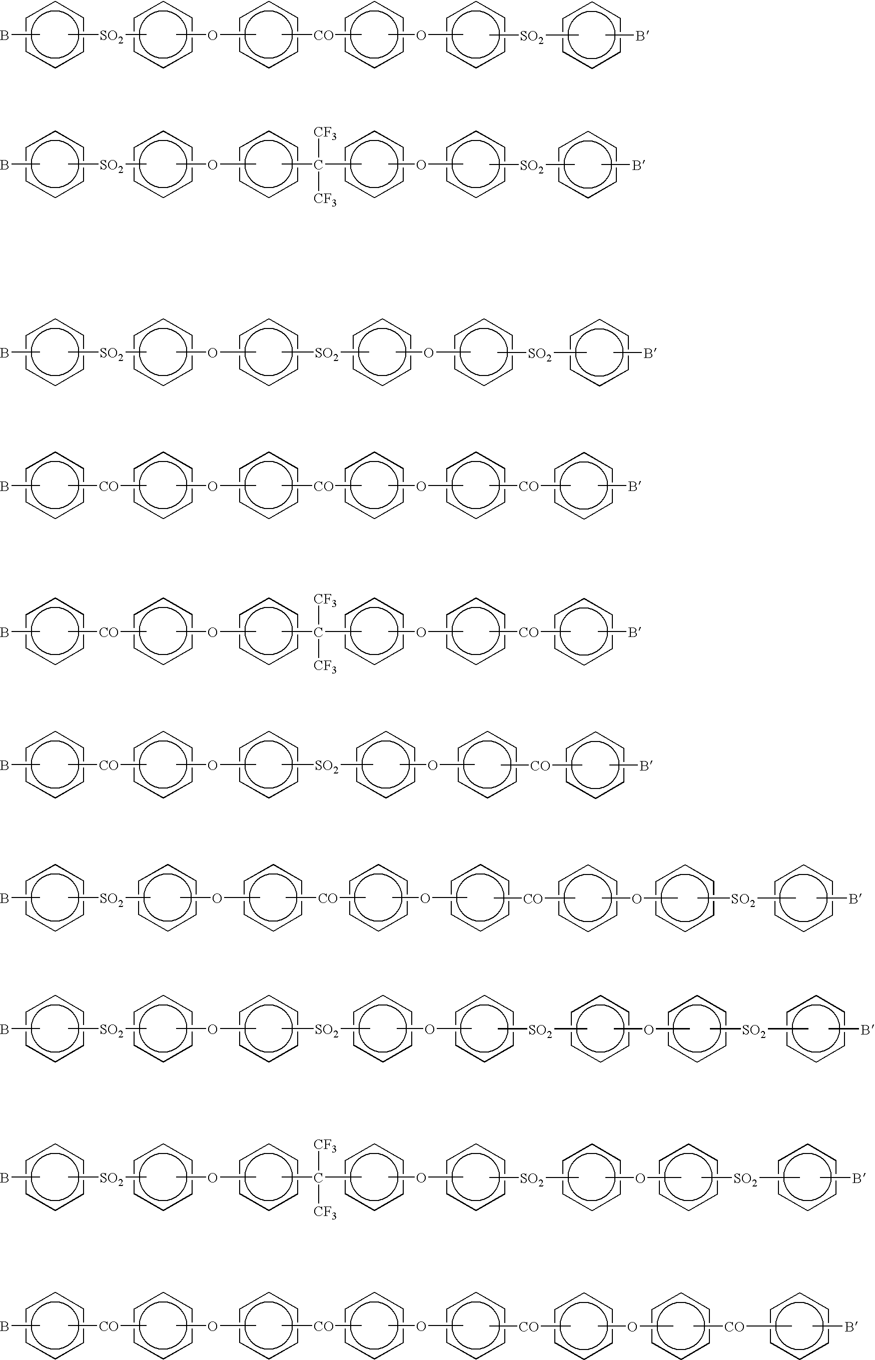

The compound (A₂) can be synthesized, for example, by means of the following method.

At the beginning, a bisphenol having phenol units linked through an electron-withdrawing group is converted into the corresponding alkali metal salt. For that purpose, the bisphenol is charged with an alkali metal such as lithium, sodium or potassium, an alkali metal hydride, an alkali metal hydroxide, an alkali metal carbonate or the like in a polar solvent having a high dielectric constant such as N-methyl-2-pyrrolidone, N,N-dimethylacetamide, sulfolane, diphenylsulfone and dimethyl sulfoxide.

Usually, a slight excess of an alkali metal is reacted with the hydroxy group of phenol, namely, in an amount of 1.1 to 2 equivalents and preferably 1.2 to 1.5 equivalents per equivalent of the hydroxy group of phenol. In this reaction, a halogen-substituted, e.g. fluorine- or chlorine-substituted, aromatic dihalide compound which is activated by an electron-withdrawing group is reacted in the concomitant presence of a solvent that can form an azeotropic mixture with water.

Examples of the solvent that can form an azeotropic mixture with water may include, for example, benzene, toluene, xylene, hexane, cyclohexane, octane, chlorobenzene, dioxane, tetrahydrofuran, anisole and phenetole. Examples of the aromatic dihalide compound may include, for example, 4,4′-difluorobenzophenone, 4,4′-dichlorobenzophenone, 4,4′-chlorofluorobenzophenone, bis(4-chlorophenyl)sulfone, bis(4-fluorophenyl)sulfone, 4-fluorophenyl-4′-chlorophenylsulfone, bis(3-nitro-4-chlorophenyl)sulfone, 2,6-dichlorobenzonitrile, 2,6-difluorobenzonitrile, hexafluorobenzene, decafluorobiphenyl, 2,5-difluorobenzophenone and 1,3-bis(4-chlorobenzoyl)benzene. From the viewpoint of reactivity, the aromatic dihalide compound is preferably a fluorine compound; however, in consideration of the successive aromatic coupling reaction, it is necessary to design the aromatic nucleophilic substitution reaction so as to yield a compound having chlorine atoms at the terminals thereof.

The active aromatic dihalide is used in an amount of 2 to 4 moles and preferably 2.2 to 2.8 moles per mole of the bisphenol. In advance of the aromatic nucleophilic substitution reaction, conversion into an alkali metal salt of bisphenol may be carried out. The reaction temperature is set to fall within a range from 60 to 300° C., and preferably from 80 to 250° C. The reaction time ranges from 15 minutes to 100 hours, and preferably from 1 to 24 hours.

A most preferable method is such that used as the active aromatic dihalide is a chlorofluoro compound having two halogen atoms different in reactivity from each other as shown in the following reaction formula (13). Accordingly, the fluorine atom preferentially undergoes the nucleophilic substitution reaction with phenoxide so that this method is favorable for obtaining the target chlorine-terminated activated compound: 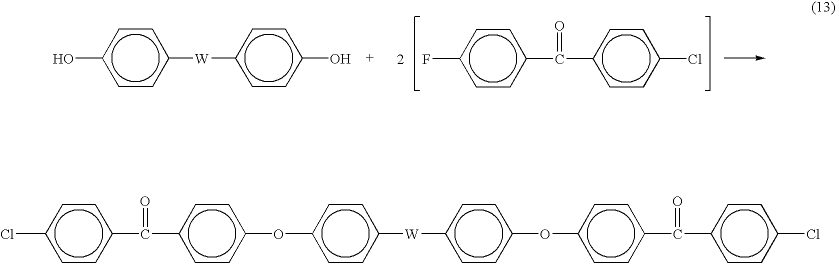
In the reaction formula (13), W is the same as in the general formula (2).

Alternatively, the compound (A₂) may be synthesized by means of a method in which the nucleophilic substitution reaction may be carried out in combination with electrophilic substitution reaction to synthesize a target flexible compound comprising electron-withdrawing and electron-donating groups (Japanese Patent Laid-Open No. 2-159).

Specifically, in the above described method, the aromatic dihalide activated by an electron-withdrawing group, such as bis(4-chlorophenyl)sulfone, undergoes nucleophilic substitution with phenol to yield a bisphenoxy substitution product. As the aromatic dihalide activated by an electron-withdrawing group to be used here, those compounds used in the reaction with the alkali metal salts of the bisphenol can be applied. The aromatic dihalide may be a substitution product when it is a phenol compound, but is preferably a non-substituted compound from the viewpoint of heat resistance and flexibility.

For the substitution reaction of phenol, it is preferable that the aromatic dihalide is converted into an alkali metal salt. Examples of the usable alkali metal compound may include the compounds used when the bisphenol is converted into an alkali metal salt. The alkali metal compound is used in an amount of 1.2 to 2 moles per mole of phenol. In the reaction, the above described polar solvents and the azeotropic solvents with water may be used.

Chlorobenzoyl chloride is reacted as an acylating agent with the bisphenoxy substitution product in the presence of an activator for the Friedel-Crafts reaction comprising Lewis acids such as aluminum chloride, boron trifluoride and zinc chloride, and the Friedel-Crafts reaction thus carried out can yield the target compound (A₂). Chlorobenzoyl chloride may be used in an amount of 2 to 4 moles and preferably 2.2 to 3 moles per mole of the bisphenoxy substitution product. The Friedel-Crafts activator is used in an amount of 1.1 to 2 equivalents per equivalent of the active halide compound of the chlorobenzoic acid or the like as an acylating agent. The reaction time is set to fall within a range from 15 minutes to 10 hours, and the reaction temperature is set to fall within a range from −20 to 80° C. As the solvent, those inert to the Friedel-Crafts reaction (such as chlorobenzene and nitrobenzene) can be used.

The polymers having m of 2 or larger in the compound (A₂) can be obtained by carrying out a substitution reaction between an alkali metal salt of the bisphenol compound and an excessive amount of an active aromatic halogen compound such as 4,4-dichlorobenzophenone or bis(4-chlorophenyl)sulfone in the presence of a polar solvent such as N-methyl-2-pyrrolidone, N,N-dimethylacetamide or sulfolane, namely, by carrying out polymerization according to the synthesis procedures for the above described individual monomers.

The bisphenol compound is a compound in which bisphenol to supply ethereal oxygen as the electron-donating group T in the general formula (11) is combined with one or more electron-withdrawing groups W selected from >C═O, —SO₂— and >C(CF₃)₂. Specific examples of such a bisphenol compound may include 2,2-bis(4-hydroxyphenyl)-1,1,1,3,3,3-hexafluoropropane, 2,2-bis(4-hydroxyphenyl)ketone and 2,2-bis(4-hydroxyphenyl)sulfone.

Examples of the polymers having m of 2 or larger in the compound (A₂) may include the following compounds. In the following compounds, 1 is 2 or more and preferably 2 to 100.

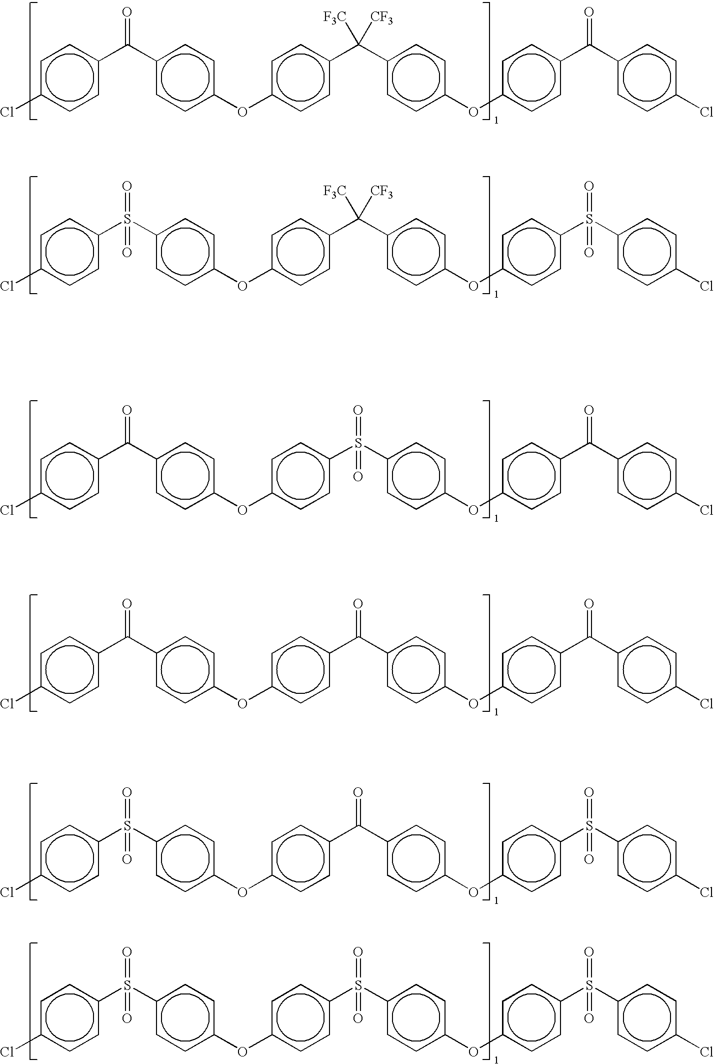

Next, the compound (A₁) as a monomer is polymerized in the presence of a catalyst in a polymerization solvent, or the compound (A₁) as a monomer and the compound (A₂) as a monomer are copolymerized in the presence of a catalyst in a polymerization solvent.

The following formula (14) shows an example of the reaction formula when the compound (A₁) as a monomer and the compound (A₂) as a monomer are copolymerized. In the following formula, x and y are positive integers. As shown in the following formula (14), the compound (A₁) and the compound (A₂) are reacted with each other at the beginning to yield a compound (A′) as a copolymer. Then, the groups of R⁹ as protective groups in the compound (A′) are removed to yield a compound (A).

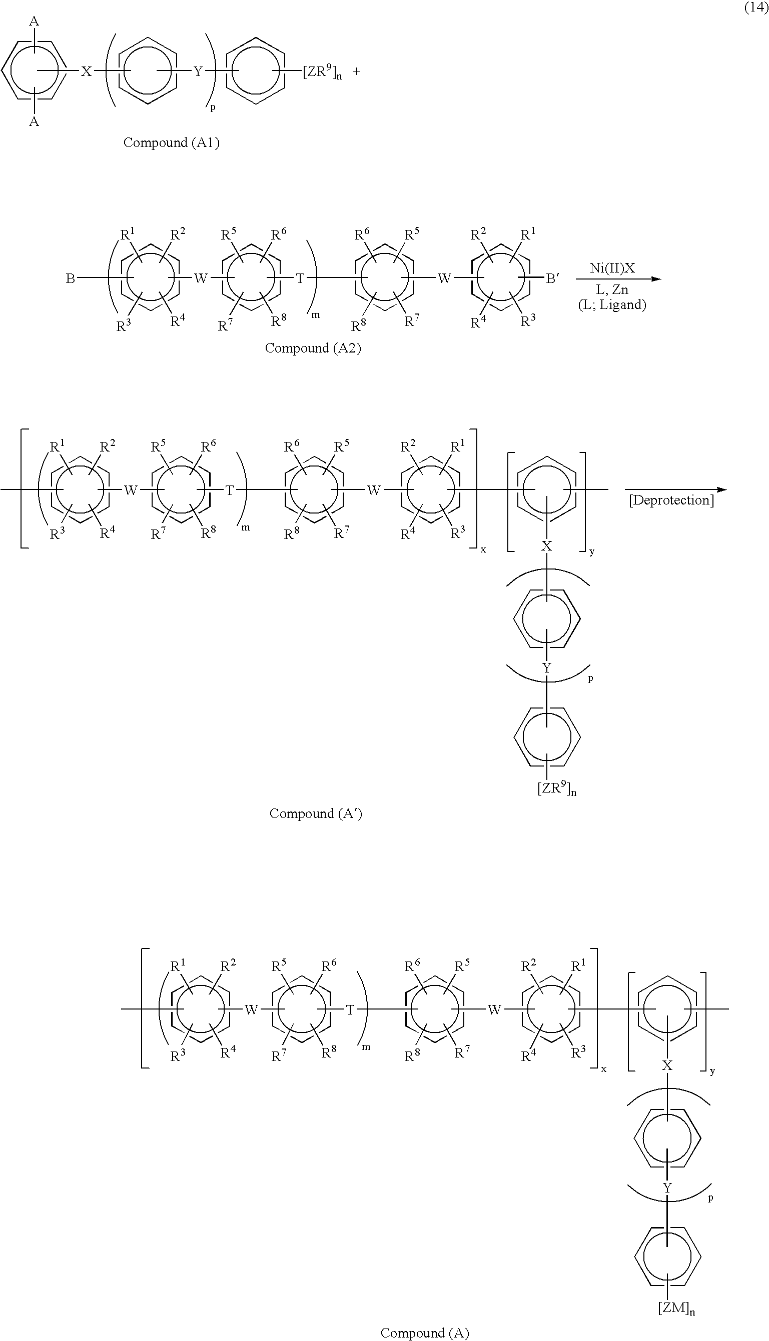

In the above copolymerization, the compound (A₁) of an amount of 0.5 to 100 mol %, preferably 10 to 99.999 mol % and the compound (A₂) of an amount of 0 to 99.5 mol %, preferably 0.001 to 90 mol % are reacted with each other.

The catalyst to be used when the compound (A₁) as a monomer is polymerized, or when the compound (A₁) as a monomer and the compound (A₂) as a monomer are copolymerized is a catalyst system comprising transition metal compounds. This catalyst system contains as indispensable components a transition metal salt and a compound which functions as a ligand (hereinafter, referred to as the “ligand component”), or a transition metal complex (including a copper salt) to which ligands are coordinated and a reducing agent; a “salt” may be added to the catalyst system in order to increase the polymerization rate.

Examples of the transition metal salt may include nickel compounds such as nickel chloride, nickel bromide, nickel iodide and nickel acetylacetonate; palladium compounds such as palladium chloride, palladium bromide and palladium iodide; iron compounds such as iron chloride, iron bromide and iron iodide; and cobalt compounds such as cobalt chloride, cobalt bromide and cobalt iodide. Particularly preferred among these are nickel chloride, nickel bromide and the like.

Examples of the ligand component may include triphenylphosphine, 2,2′-bipyridine, 1,5-cyclooctadiene and 1,3-bis(diphenylphosphino)propane. Preferred among these are triphenylphosphine and 2,2′-bipyridine. These compounds as the ligand components may be used each alone or in combinations of two or more thereof.

Examples of the transition metal complexes with the ligand components coordinated thereto may include nickel chloride-bis(triphenylphosphine), nickel bromide-bis(triphenylphosphine), nickel iodide-bis(triphenylphosphine), nickel nitrate-bis(triphenylphosphine), nickel chloride(2,2′-bipyridine), nickel bromide(2,2′-bipyridine), nickel iodide(2,2′-bipyridine), nickel nitrate(2,2′-bipyridine), bis(1,5-cyclooctadiene)nickel, tetrakis(triphenylphosphine)nickel, tetrakis(triphenylphosphite)nickel and tetrakis(triphenylphosphine)palladium. Preferred among these are nickel chloride-bis (triphenylphosphine) and nickel chloride(2,2′-bipyridine).

Examples of the reducing agent usable in the catalyst system may include, for example, iron, zinc, manganese, aluminum, magnesium, sodium and calcium. Preferred among these are zinc, magnesium and manganese. These reducing agents can be used in a more activated form by being brought into contact with an acid such as an organic acid.

Examples of the “salt” usable in the catalyst system may include sodium compounds such as sodium fluoride, sodium chloride, sodium bromide, sodium iodide and sodium sulfate; potassium compounds such as potassium fluoride, potassium chloride, potassium bromide, potassium iodide and potassium sulfate; and ammonium compounds such as tetraethylammonium fluoride, tetraethylammonium chloride, tetraethylammonium bromide, tetraethylammonium iodide and tetraethylammonium sulfate. Preferred among these are sodium bromide, sodium iodide, potassium bromide, tetraethylammonium bromide and tetraethylammonium iodide.

The used amount of the transition metal salt or the transition metal complex is usually 0.0001 to 10 mol, and preferably 0.01 to 0.5 mol in relation to 1 mol of the total amount of the monomers. When the used amount is less than 0.0001 mol, the polymerization reaction sometimes does not proceed to a sufficient extent, while when the used amount exceeds 10 mol, the molecular weight of the obtained polymer is sometimes decreased.

When the transition metal salt and the ligand component are used in the catalyst system, the used amount of the ligand component is usually 0.1 to 100 mol, and preferably 1 to 10 mol in relation to 1 mol of the transition metal salt. When the used amount is less than 0.1 mol, the catalytic activity sometimes becomes insufficient, while when the used amount exceeds 100 mol, the molecular weight of the obtained polymer is sometimes decreased.

The used amount of the reducing agent is usually 0.1 to 100 mol, and preferably 1 to 10 mol in relation to 1 mol of the total amount of the monomers. When the used amount is less than 0.1 mol, the polymerization sometimes does not proceed to a sufficient extent, while when the used amount exceeds 100 mol, the purification of the obtained polymer sometimes becomes difficult.

When the “salt” is used, the used amount thereof is usually 0.001 to 100 mol, and preferably 0.01 to 1 mol in relation to 1 mol of the total amount of the monomers. When the used amount is less than 0.001 mol, sometimes an effect of increasing the polymerization rate is insufficient, while when the used amount exceeds 100 mol, the purification of the obtained polymer sometimes becomes difficult.

Examples of the polymerization solvent may include, for example, tetrahydrofuran, cyclohexanone, dimethyl sulfoxide, N,N-dimethylformamide, N,N-dimethylacetamide, N-methyl-2-pyrrolidone, γ-butyrolactone, sulfolane, γ-butyrolactam, dimethylimidazolidinone and tetramethylurea. Preferred among these are tetrahydrofuran, N,N-dimethylformamide, N,N-dimethylacetamide and N-methyl-2-pyrrolidone. These polymerization solvents are used preferably after being dried sufficiently.

The total concentration of the monomers in the polymerization solvent is usually 1 to 90 wt %, and preferably 5 to 40 wt %. The polymerization temperature is usually 0 to 200° C., and preferably 50 to 120° C. The polymerization time is usually 0.5 to 100 hours, and preferably 1 to 40 hours.

The solid polymer electrolyte membrane 1 is prepared by use of a polymer electrolyte comprising the polyarylene polymer. When the solid polymer electrolyte membrane 1 is prepared, in addition to the polymer electrolyte, inorganic acids such as sulfuric acid and phosphoric acid, organic acids including carboxylic acids, an appropriate amount of water and the like may be used in combination.

The solid polymer electrolyte membrane 1 can be produced by a method (the casting method) in which the polyarylene polymer is dissolved in a solvent to prepare a solution, and then the solution is flow-cast by casting on a substrate to form the solid polymer electrolyte membrane as a film. No particular constraint is imposed on the substrate as long as the substrate is a substrate used in the common solution casting method; for example, plastic substrates and metal substrates can be used, and preferably a substrate made of a thermoplastic resin such as a polyethylene terephthalate (PET) film can be used.

Examples of the solvent for dissolving the polyarylene polymer may include, for example, aprotic polar solvents such as N-methyl-2-pyrrolidone, N,N-dimethylformamide, y-butyrolactone, N,N-dimethylacetamide, dimethylsulfoxide, dimethylurea and dimethylimidazolidinone. Preferred among these aprotic polar solvents is N-methyl-2-pyrrolidone (hereinafter, also referred to as “NMP”) from the viewpoint of solubility and solution viscosity. These aprotic polar solvents may be used each alone or in combinations of tow or more thereof.

Alternatively, as the solvent for dissolving the polyarylene polymer, mixtures of these aprotic polar solvents with alcohols can also be used. Examples of such alcohols may include methanol, ethanol, propyl alcohol, iso-propyl alcohol, sec-butyl alcohol and tert-butyl alcohol; particularly, methanol is preferable because methanol has an effect of decreasing the solution viscosity over a wide range of composition. These alcohols may be used each alone or in combinations of two or more thereof.

When a mixture of the aprotic polar solvent(s) and an alcohol (or alcohols) is used as the solvent, the amount of the aprotic polar solvent(s) is set at 95 to 25 wt %, preferably at 90 to 25 wt %, and the amount of the.alcohol (or alcohols) is set at 5 to 75 wt %, preferably 10 to 75 wt %, with the proviso that the total amount is 100 wt %. The alcohol(s) can attain an excellent effect in decreasing the solution viscosity when the amount thereof falls within the above described range.

The polymer concentration of the solution dissolving the polyarylene polymer is usually 5 to 40 wt %, preferably 7 to 25 wt % although the concentration concerned is dependent on the molecular weight of the polyarylene polymer. When the concentration is less than 5 wt %, it is difficult to increase the thickness of the film, and pinholes tend to be formed in the obtained films. On the other hand, when the concentration exceeds 40 wt %, the solution viscosity becomes too high to prepare film, and sometimes the obtained film tends to be degraded in surface flatness and smoothness.

Although the solution viscosity depends on the molecular weight of the polyarylene polymer and the polymer concentration, the solution viscosity is usually 2,000 to 100,000 mPa·s, preferably 3,000 to 50,000 mPa·s. When the solution viscosity is less than 2,000 mPa·s, the retention of the solution in the course of film formation is so poor that sometimes the solution flows out of the substrate. On the other hand, when the solution viscosity exceeds 100,000 mPa·s, the viscosity is too high to inhibit the extrusion from the die, and sometimes the film formation based on the casting method becomes difficult.

After a film has been formed as described above, soaking of the obtained non-dried film in water makes it possible to replace the organic solvent in the non-dried film with water, and consequently reduce the amount of the residual solvent in the obtained solid polymer electrolyte membrane 1.

After formation of the non-dried film and before soaking it in water, it may be subjected to predrying. The predrying can be carried out usually by maintaining the non-dried film at temperatures of 50 to 150° C. for 0.1 to 10 hours.

The treatment of soaking the non-dried film in water may adopt a batch method in which a single sheet of film is soaked in water at a time, or a continuous method in which a laminated film usually obtained as formed on a substrate film (for example, PET) is soaked, as it is or as a film separated from the substrate, in water and then taken up in a roll. In the batch method, by adopting a method in which the film is fit in a frame or the like, the wrinkle formation on the surface of the treated film is suppressed in a favorable manner.

When the non-dried film is soaked in water, the contact ratio is preferably such that 10 parts by weight or more, preferably 30 parts by weight or more of water is used in relation to 1 part by weight of the non-dried film. For the purpose of making the amount of the residual solvent in the obtained solid polymer electrolyte membrane 1 as small as possible, it is preferable to maintain an as large as possible contact ratio. For the purpose of maintaining an as large as possible contact ratio, it is effective that the water used in soaking is replaced or is made to overflow in such a way that the concentration of the organic solvent in water is always maintained at a predetermined concentration or below. For the purpose of making smaller the in-plain distribution of the organic solvent remaining in the solid polymer electrolyte membrane 1, it is effective that the concentration of the organic solvent in the soaking water is homogenized by stirring the water or the like.

When the non-dried film is soaked in water, the temperature of the water is set to fall preferably within a range from 5 to 80° C. With increasing water temperature, the rate of the replacement of the organic solvent with water is increased, but the amount of the water absorbed by the film is also increased, so that there is an apprehension that the surface conditions of the solid polymer electrolyte membrane 1 obtained after drying will be roughened. Usually, from the viewpoints of the replacement rate and the easy handlability, the water temperature is favorably set to fall within a range from 10 to 60° C. The soaking time depends on the initial residual amount of the solvent, the contact ratio and the treatment temperature; however, the soaking time is set to fall within a range usually from 10 minutes to 240 hours, and preferably from 30 minutes to 100 hours.

When the non-dried film is soaked in water and then dried as described above, the solid polymer electrolyte film 1 with the reduced amount of the residual solvent is obtained, and the amount of the residual solvent in the solid polymer electrolyte membrane 1 is usually 5 wt % or less.

Depending on the soaking conditions, the amount of the residual solvent in the obtained solid polymer electrolyte membrane 1 can be made to be 1 wt % or less. Examples of such conditions may include, for example, the conditions that the contact ratio between the non-dried film and water is set such that 1 part by weight of the non-dried film is soaked in 50 parts by weight or more of water, the water temperature in soaking is set at 10 to 60° C., and the soaking time is set at 10 minutes to 10 hours.

After the non-dried film has been soaked in water as described above, the film is dried at 30 to 100° C., preferably at 50 to 80° C., for 10 to 180 minutes, preferably for 15 to 60 minutes, and then vacuum dried at 50 to 150° C. preferably under a reduced pressure of 500 to 0.1 mmHg for 0.5 to 24 hours, and thus the solid polymer electrolyte membrane 1 can be obtained.

The dry membrane thickness of the solid polymer electrolyte membrane 1 obtained on the basis of the above described production method is usually 10 to 100 μm, and preferably 20 to 80 μm.

The solid polymer electrolyte membrane 1 may include an antiaging agent, preferably a hindered phenol compound having a molecular weight of 500 or more; the inclusion of an antiaging agent can further improve the durability.

Examples of the hindered phenol compound having a molecular weight of 500 or more may include:
triethyleneglycol-bis[3-(3-t-butyl-5-methyl-4-hydroxyphenyl)propionate] (trade name: IRGANOX 2454),
1,6-hexanediol-bis[3-(3,5-di-t-butyl-4-hydroxyphenyl)propionate] (trade name: IRGANOX 259),
2,4-bis-(n-octylthio)-6-(4-hydroxy-3,5-di-t-butylanilino)-3,5-triazine (trade name: IRGANOX 565),
pentaerythrityl-tetrakis[3-(3,5-di-t-butyl-4-hydroxyphenyl)propionate] (trade name: IRGANOX 1010),
2,2-thio-diethylene-bis[3-(3,5-di-t-butyl-4-hydroxyphenyl)propionate] (trade name: IRGANOX 1035),
octadecyl-3-(3,5-di-t-butyl-4-hydroxyphenyl)propionate (trade name: IRGANOX 1076),
N,N-hexamethylenebis(3,5-di-t-butyl-4-hydroxy-hydrocinnamamide) (trade name: IRGANOX 1098),
1,3,5-trimethyl-2,4,6-tris(3,5-di-t-butyl-4-hydroxybenzyl)benzene (trade name: IRGANOX 1330),
tris-(3,5-di-t-butyl-4-hydroxybenzyl)-isocyanurate (trade name: IRGANOX 3114) and
3,9-bis[2-(3-(3-t-butyl-4-hydroxy-5-methylphenyl)propionyloxy}-1,1-dimethylethyl]-2,4,8,10-tetraoxaspiro[5.5]undecane (trade name: Sumilizer GA-80). The hindered phenol compounds having a molecular weight of 500 or more each are preferably used in an amount of 0.01 to 10 parts by weight in relation to 100 parts by weight of the polyarylene polymer.

Next, examples and comparative examples of the present invention will be described below.

### EXAMPLE 1

In the present example, at the beginning, in a 2-liter three-necked flask equipped with a stirrer, a nitrogen introducing tube and a dropping funnel, 64.9 g (600 mmol) of anisole and 480 ml of dichloromethane were placed and cooled down to 10° C. in an ice bath, and then 80 g (600 mmol) of aluminum chloride was added. Then, 125.7 g (600 mmol) of 2,5-dichlorobenzoyl chloride was slowly dropped from the dropping funnel. On completion of dropping, 80 g (600 mmol) of aluminum chloride was further added. Then, the temperature of the reaction mixture was brought back to room temperature, and stirring was continued for 12 hours.

Next, the obtained reaction solution was poured into 2 liters of ice water containing 300 ml of concentrated hydrochloric acid, and the separated organic layer was extracted with a 10% aqueous solution of sodium hydroxide. Then, the sodium hydroxide was neutralized with hydrochloric acid, and the precipitated solid product was extracted with 2 liters of ethyl acetate. The solvent was distilled off, and the obtained solid product was recrystallized with a mixed solvent of ethyl acetate and n-hexane to yield 136.3 g of 2,5-dichloro-4′-hydroxybenzophenone (the compound (A₁′-1)) (yield: 85%).

Next, 26.7 g (100 mmol) of 2,5-dichloro-4′-hydroxybenzophenone as the compound (A₁′-1), 100 g (1200 mmol) of 2H-dihydropyran and 100 ml of toluene were placed in a flask; 1.5 g of a cation exchange resin (Amberlyst-15 (trade name)) was added under stirring, and the reaction mixture thus obtained was stirred for 5 hours at room temperature; then, the cation exchange resin was removed by filtration. Then, the obtained filtrate was washed with an aqueous solution of sodium hydroxide and an aqueous solution of sodium chloride, dried with magnesium sulfate, and then the solvent was distilled off. The obtained solid product was recrystallized with toluene to yield 16.4 g of 2,5-dichloro-4′-(tetrahydro-2-pyranyloxy)benzophenone (the compound (A₁-1))(yield: 47%).

The above described steps are shown in the following reaction formula (15):

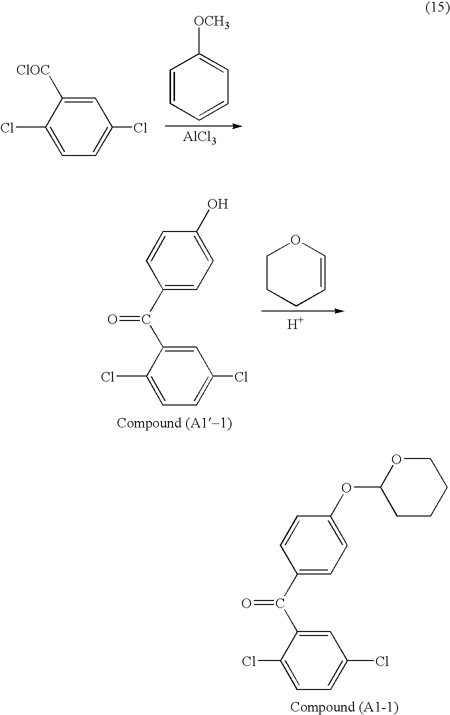

Next, in a 500-ml flask equipped with stirring blades, a thermometer and a nitrogen introducing tube, 15.6 g (44.4 mmol) of 2,5-dichloro-4′-(tetrahydro-2-pyranyloxy)benzophenone as the compound (A₁-1), 6.55 g (0.585 mmol) of a 4,4′-dichlorobenzophenone/2,2-bis(4-hydroxyphenyl)-1,1,1,3,3,3-hexafluoropropane polycondensate (the number average molecular weight: 11,200) as the compound (A₂), 0.883 g (1.35 mmol) of bis(triphenylphosphine)nickel dichloride, 0.877 g (5.85 mmol) of sodium iodide, 4.72 g (18 mmol) of triphenylphosphine and 7.06 g (108 mmol) of zinc were placed and vacuum dried. Then, the atmosphere inside the flask was replaced with dry nitrogen, and thereafter 52 ml of N,N-dimethylacetamide (DMAc) was added, and polymerization was carried out under controlling the temperature of the reaction solution so as to fall within a range from 70 to 90° C. After 3 hours, the reaction solution was diluted by adding 200 ml of DMAc, the insoluble matter was removed by filtration to yield a polymer filtrate solution.

A trace amount of the polymer filtrate solution was sampled, and the sample thus obtained was poured into methanol to precipitate the polymer, the precipitate was separated by filtration, the precipitate was dried to yield a solid product, and from the ¹H-NMR spectrum of the dried solid product, the solid product was verified to have the tetrahydro-2-pyranyl group, and the structure of the solid product was inferred to be the structure of the compound (A′-1). As for the solid product, the number average molecular weight and the weight average molecular weight as measured with tetrahydrofuran (THF) as solvent by gel permeation chromatography (GPC) relative to polystyrene standards were 28,000 and 103,000, respectively.

On the other hand, the remaining polymer filtrate solution was poured into 1.5 liters of methanol containing 10 vol % of concentrated hydrochloric acid to precipitate the polymer. Then, the precipitate was separated by filtration, the thus obtained solid product was dried to yield 14.3 g of a polymer having hydroxy group (the compound (A-1)). From the ¹H-NMR spectrum of the compound (A-1), the polymer was verified to have hydroxy groups. The above described steps are shown in the following reaction formula (16). In the reaction formula (16), d, e and f are positive integers.

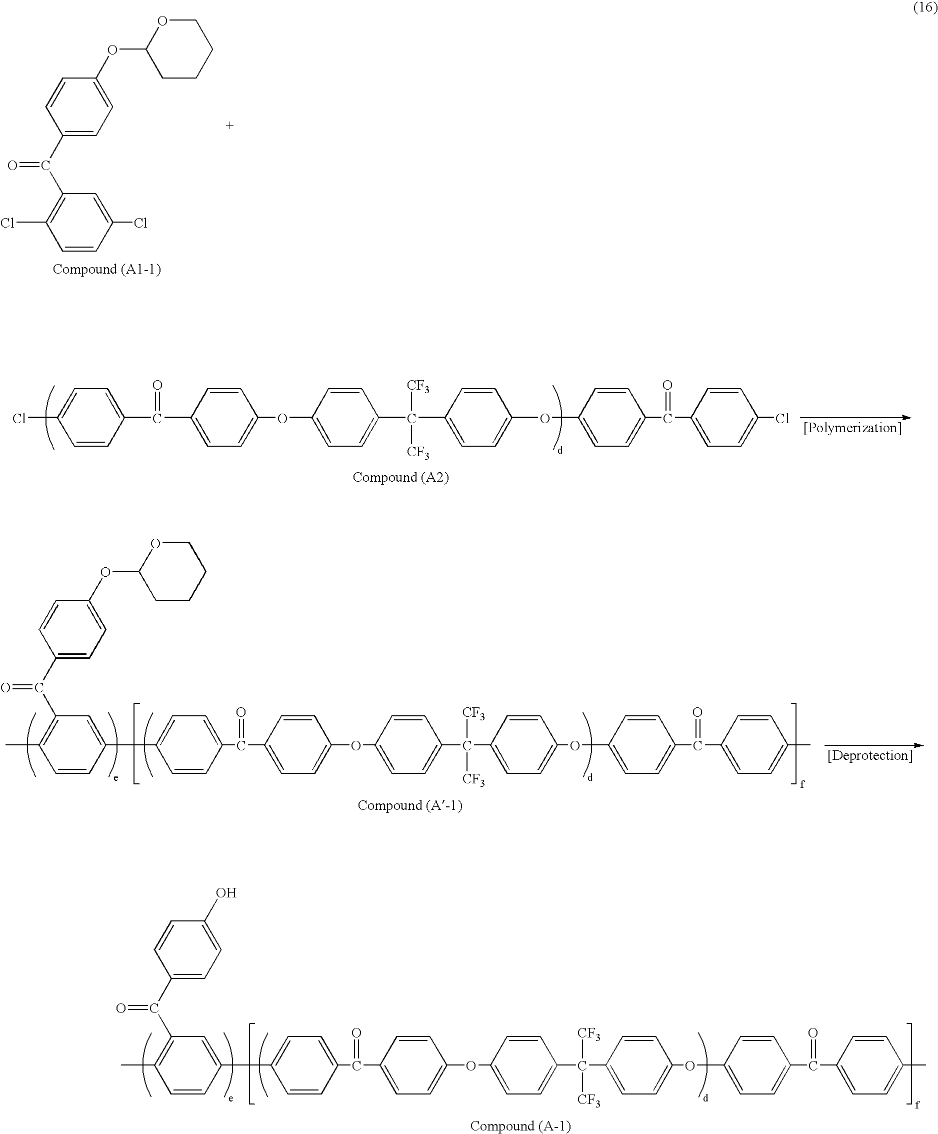

Next, 15.2 g of the compound (A-1) was added to 250 ml of N,N-dimethylacetamide (DMAc), and dissolved by stirring under heating to 100° C. Then, 1.06 g (133 mmol) of lithium hydride was added to the reaction solution, and the reaction solution was stirred for 2 hours. Successively, 16.2 g (133 mmol) of propanesultone as the compound (B-1) was added to the reaction solution, and the reaction was allowed to proceed for 8 hours. Then, the insoluble matter of the obtained reaction solution was removed by filtration, and the filtrate was poured into 1 M hydrochloric acid to precipitate the polymer. The precipitated polymer was washed with 1 M hydrochloric acid, and thereafter was washed with distilled water until the wash water became neutral. The polymer was dried at 75° C. to yield 19.2 g of the powdery polymer. From the ¹H-NMR spectrum of the polymer, the polymer was verified to be a polyarylene copolymer having sulfonic acid groups (the compound (1)). The above described steps are shown in the following reaction formula (17). In the reaction formula (17), d, e and f are positive integers.

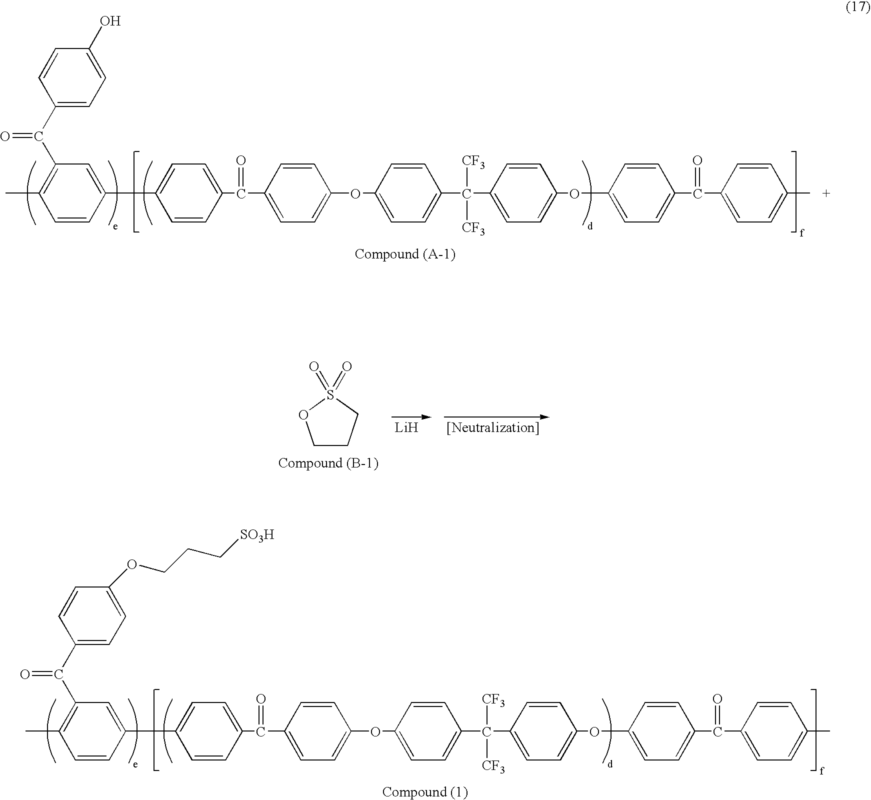

Next, the polyarylene copolymer (the compound (1)) obtained in the present example was dissolved in NMP/methanol so as to give a concentration of 18 wt %, and thereafter, a solid polymer electrolyte membrane having a dry membrane thickness of 40 μm was obtained by the casting method.

Next, platinum particles were supported by carbon black (furnace black) having an average particle size of 50 nm at a weight ratio of carbon black:platinum=1:1 (weight percentage loading: 50%) to prepare catalyst particles. Next, the catalyst particles were evenly dispersed in a solution of perfluoroalkylene sulfonic acid polymer compound (Nafion (tradename) manufactured by DuPont Corp.) as anion-conductive binder at a weight ratio of ion-conductive binder:catalyst particles=8:5 (containing the ion-conductive binder of 0.6 time the mass of the catalyst particles) to prepare a catalyst paste.

Next, carbon black and polytetrafluoroethylene (PTFE) particles are mixed together in a weigh ratio of carbon black: PTFE particles=4:6, and the obtained mixture was evenly dispersed in ethylene glycol to prepare a slurry; the slurry was applied onto one side of a sheet of carbon paper and dried to form a base layer; thus, two gas diffusion layers each composed of the base layer and carbon paper were prepared.

Next, both sides of the solid polymer electrolyte membrane were coated with the catalyst paste so as for the platinum content to be 0.5 mg/cm² with a bar coater and dried to obtain an electrode coated membrane (CCM). The drying was carried out at 100° C. for 15 minutes, as a primary drying and at 140° C. for 10 minutes as a secondary drying subsequent to the primary drying.

Next, the CCM was sandwiched between the base layer sides of the gas diffusion layers, and hot pressed to obtain a membrane-electrode assembly. The hot pressing was carried out at 80° C. and 5 MPa for 2 minutes as a primary hot pressing and at 160° C. and 4 MPa for 1 minute as a secondary hot pressing subsequent to the primary hot pressing.

The membrane-electrode assembly obtained in the present example can constitute a solid polymer electrolyte fuel cell by further laminating separators doubling as gas channels on the gas diffusion layers.

Next, the physical properties of the polyarylene copolymer, the solid polymer electrolyte membrane, and the membrane-electrode assembly obtained in the present example were evaluated as follows. The results obtained are shown in Table 1.

[Acid Equivalent of the Sulfonic Acid Group (Ion-Exchange Capacity)]

The polyarylene copolymer obtained in the present example was washed with distilled water until the wash water became neutral in order to sufficiently remove the residual free acid, then dried and a predetermined amount thereof was weighed out to dissolve in a THF/water mixed solvent. Next, the solution was titrated with a standard solution of sodium hydroxide using phenolphthalein as an indicator, and the acid equivalent (ion-exchange capacity) (meq/g) of the sulfonic acid group was obtained from the point of neutralization.

[Proton Conductivity]

First, the solid polymer electrolyte membrane obtained in the present example was cut into a 5 mm wide strip specimen. Next, a plurality of platinum wires (diameter: 0.5 mm) were pressed against the surface of the specimen, the specimen was hold in a constant temperature and constant humidity chamber, and the alternating current resistance of the specimen was obtained by measuring the alternating current impedance between the platinum wires at a alternating frequency of 10 kHz under conditions of 85° C. and a relative humidity of 90%. As the resistance measurement apparatus, a SI1260 Impedance Analyzer (trade name) manufactured by Solartron Co., Ltd. was used, and as the constant temperature and constant humidity chamber, a benchtop environmental test chamber SH-241 (trade name) manufactured by Espec Co., Ltd. was used. Against the specimen, 5 platinum wires were pressed with even intervals of 5 mm therebetween, and the alternating current resistance values were measured with the inter-wire distances varied from 5 to 20 mm. Next, from a gradient of the resistance to inter-wire distance, the specific resistance of the solid polymer electrolyte membrane was derived from the following formula, the alternating current impedance was derived from the reciprocal number of the specific resistance, and the proton conductivity was derived from the impedance.
Specific resistance (Ω·cm)=0.5 (cm)×membrane thickness (cm)×gradient of resistance to inter-wire distance ((Ω/cm)
[Hot-Water Resistance]

The solid polymer electrolyte membrane obtained in the present example was soaked in hot water at 95° C. for 48 hours; the ratio of the weight of the solid polymer electrolyte membrane after soaking to the weight of the solid polymer electrolyte membrane before soaking was defined as the weight retention rate (%) to be used as the index of the hot-water resistance.

[Thermal Decomposition Initiation Temperature]

The solid polymer electrolyte membrane obtained in the present example was heated with a thermogravimetric analyzer (TGA), under conditions of an atmosphere of nitrogen and the temperature increase rate of 20° C./min, and the temperature at which the decomposition of the solid polymer electrolyte membrane started was taken as the thermal decomposition initiation temperature (° C.).

[Resistance to Fenton's Reagent]

Fenton's reagent was prepared by dissolving ferrous sulfate in a hydrogen peroxide solution diluted to 3 wt % with pure water so as for the ferrous ion (Fe²⁺) concentration to be 20 ppm. Next, the solid polymer electrolyte membrane obtained in the present example cut to a predetermined size was soaked in Fenton's reagent and allowed to stand at 45° C. for 20 hours therein. And, the ratio of the weight of the solid polymer electrolyte membrane after soaking to the weight of the solid polymer electrolyte membrane before soaking was defined as the weight retention rate (%) to be used as the index of the resistance to Fenton's reagent.

[Electric Power Generation Performance]

By using the membrane-electrode assembly obtained in the present example, electric power generation was carried out by supplying pure hydrogen to the fuel electrode side and air to the oxygen electrode side under the electric power generation conditions that the temperature was set at 70° C., the relative humidity of the fuel electrode side was set at 70% and the relative humidity of the oxygen electrode side was set at 70%. After the 300-hour electric power generation at an electric current density of 1 A/cm², the cell voltage was measured at an electric current density of 1 A/cm² to be used as the index of electric power generation performance of the membrane-electrode assembly.

### EXAMPLE 2

The reaction was carried out in the same manner as in Example 1 except that 18.1 g (133 mmol) of butanesultone as the compound (B-2) was used in place of 16.2 g (133 mmol) of propanesultone as the compound (B-1) in Example 1 to yield 20.8 g of a polyarylene copolymer (compound (2)) having sulfonic acid groups as a powdery polymer. The above described steps are shown in the following reaction formula (18). In the reaction formula (18), d, e and f are positive integers.

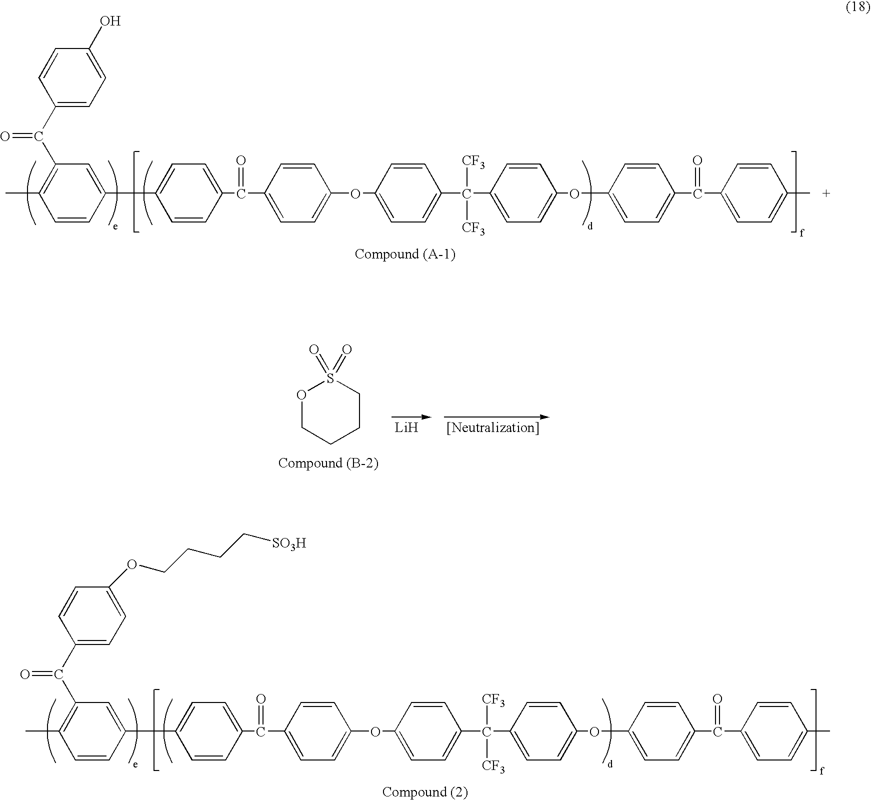

Next, a membrane-electrode assembly was fabricated in the same manner as in Example 1 except that the polyarylene copolymer (compound (2)) obtained in the present example was used.

Next, the physical properties of the polyarylene copolymer, the solid polymer electrolyte membrane, and the membrane-electrode assembly obtained in the present example were evaluated in the same manner as in Example 1. The results obtained are shown in Table 1.

### EXAMPLE 3

In the present example, at the beginning, in a 2-liter three-necked flask equipped with a stirrer, a nitrogen introducing tube and a dropping funnel, 33.2 g (240 mmol) of 1,3-dimethoxybenzene and 300 ml of dichloromethane were placed and cooled down to 10° C. in an ice bath, and then 32 g (240 mmol) of aluminum chloride was added. Then, 50.3 g (240 mmol) of 2,5-dichlorobenzoyl chloride was slowly dropped from the dropping funnel. On completion of dropping, 32 g (240 mmol) of aluminum chloride was further added. Then, the temperature of the reaction mixture was brought back to room temperature, and stirring was continued for 12 hours.

Then, the obtained reaction solution was poured into 1 liter of ice water containing 150 ml of concentrated hydrochloric acid, and the separated organic layer was extracted with a 10% aqueous solution of sodium hydroxide. Then, the sodium hydroxide was neutralized with hydrochloric acid, and the precipitated solid product was extracted with 1 liter of ethyl acetate. The solvent was distilled off, and the obtained solid product was recrystallized with a mixed solvent of ethyl acetate and n-hexane to yield 57 g of 2,5-dichloro-2′,4′-dihydroxybenzophenone (the compound (A₁′-2)) (yield: 76%).

Next, 28.3 g (100 mmol) of 2,5-dichloro-2′,4′-dihydroxybenzophenone as the compound (A₁′-2), 200 g (2400 mmol) of 2H-dihydropyran and 100 ml of toluene were placed in a flask; 3.0 g of a cation exchange resin (Amberlyst-15 (trade name)) was added under stirring, and the reaction mixture thus obtained was stirred for 5 hours at room temperature; then, the cation exchange resin was removed by filtration. Then, the obtained filtrate was washed with an aqueous solution of sodium hydroxide and an aqueous solution of sodium chloride, dried with magnesium sulfate, and then the solvent was distilled off. The obtained solid product was recrystallized with toluene to yield 21.2 g of 2,5-dichloro-2′,4′-di(tetrahydro-2-pyranyloxy)benzophenone (the compound (A₁-2)) (yield: 47%). The above described steps are shown in the following reaction formula (19).

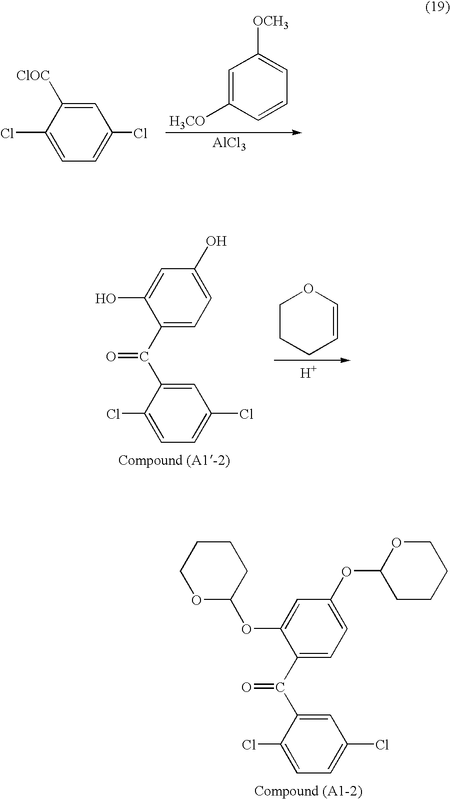

Next, in a 500-ml flask equipped with stirring blades, a thermometer and a nitrogen introducing tube, 19.45 g (43.1 mmol) of 2,5-dichloro-2′,4′-di(tetrahydro-2-pyranyloxy)benzophenone as the compound (A₁-2), 20.12 g (1.80 mmol) of a 4,4′-dichlorobenzophenone/2,2-bis(4-hydroxyphenyl)-1,1,1,3,3,3-hexafluoropropane polycondensate (the number average molecular weight: 11,200) as the compound (A₂-2), 0.883 g (1.35 mmol) of bis(triphenylphosphine)nickel dichloride, 0.877 g (5.85 mmol) of sodium iodide, 4.72 g (18 mmol) of triphenylphosphine and 7.06 g (108 mmol) of zinc were placed and vacuum dried. Then, the atmosphere inside the flask was replaced with dry nitrogen, and thereafter 87 ml of DMAc was added, and polymerization was carried out under controlling the temperature of the reaction solution so as to fall within a range from 70 to 90° C. After 3 hours, the reaction solution was diluted by adding 200 ml of DMAc, the insoluble matter was removed by filtration to yield a polymer filtrate solution. It is inferred that this polymer filtrate solution contained the compound (A′-2), and the compound (A′-2) had tetrahydro-2-pyranyl groups. Then, the polymer filtrate solution was poured into 1.5 liters of methanol containing 10 vol % of concentrated hydrochloric acid to precipitate the polymer. Then, the precipitate was separated by filtration, and thereafter the obtained solid product was dried to yield 28.5 g of the polymer having hydroxy groups (the compound (A-2)) The above described steps are shown in the following reaction formula (20). In the reaction formula (20), d, e and f are positive integers.

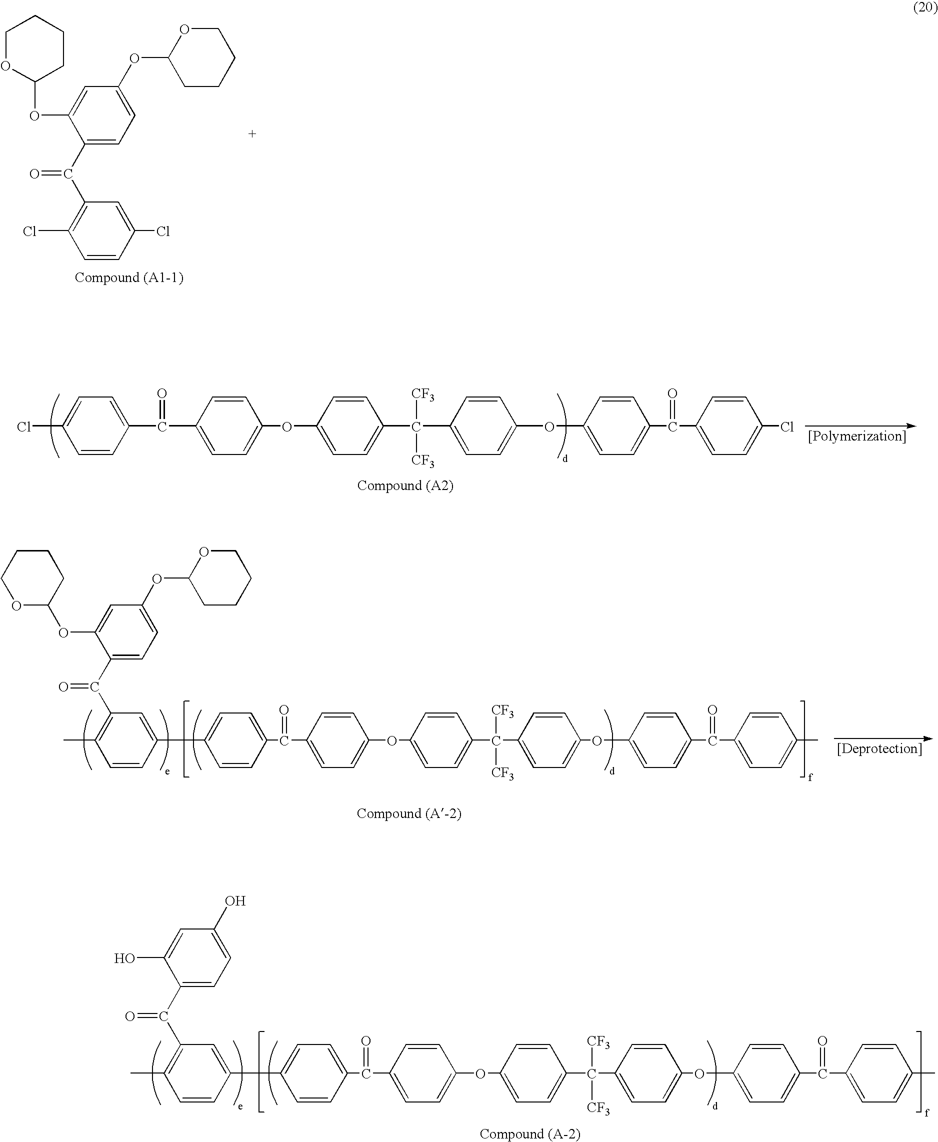

Next, 29.1 g of the compound (A-2) was added to 500 ml of DMAc, and dissolved by stirring under heating to 100° C. Then, 2.06 g (258 mmol) of lithium hydride was added to the reaction solution, and the reaction solution was stirred for 2 hours. Successively, 31.6 g (258 mmol) of propanesultone as the compound (B-1) was added to the reaction solution, and the reaction was allowed to proceed for 8 hours. Then, the insoluble matter of the obtained reaction solution was removed by filtration, and the filtrate was poured into 1 M hydrochloric acid to precipitate the polymer. The precipitated polymer was washed with 1 M hydrochloric acid, and thereafter was washed with distilled water until the wash water became neutral. The polymer was dried at 75° C. to yield 38.2 g of a polyarylene copolymer (the compound (3)) having sulfonic acid groups as a powdery polymer. The above described steps are shown in the following reaction formula (21). In the reaction formula (21), d, e and f are positive integers.

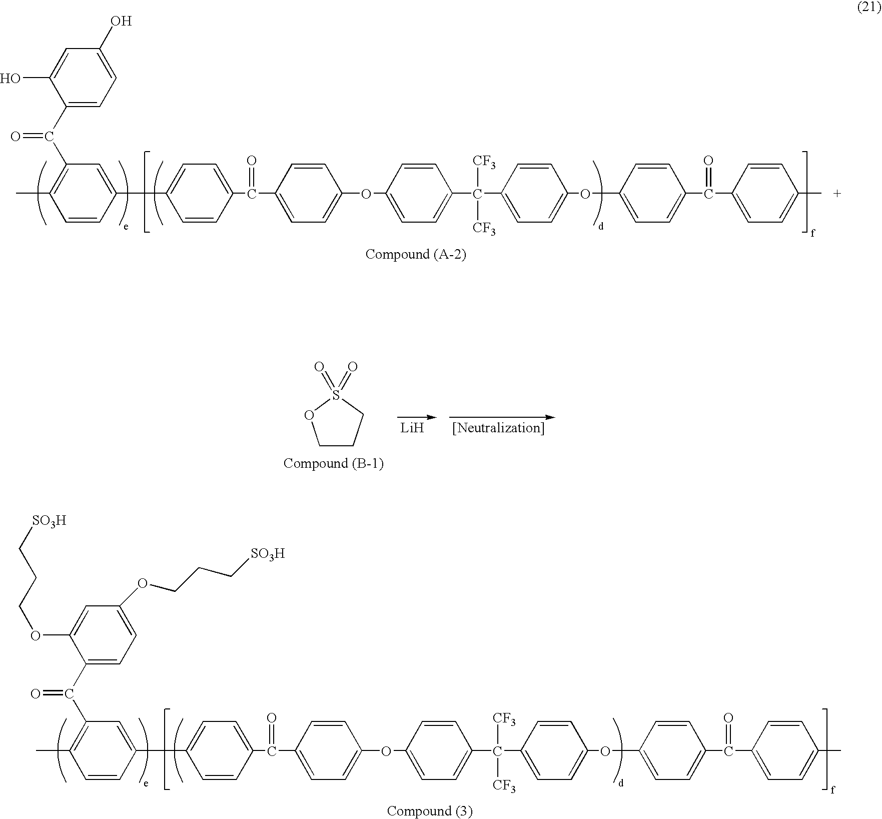

Next, a membrane-electrode assembly was fabricated in the same manner as in Example 1 except that the polyarylene copolymer (compound (3)) obtained in the present example was used.

Next, the physical properties of the polyarylene copolymer, the solid polymer electrolyte membrane, and the membrane-electrode assembly obtained in the present example were evaluated in the same manner as in Example 1. The results obtained are shown in Table 1.

### EXAMPLE 4

In the present example, at the beginning, in a 2-liter three-necked flask equipped with a stirrer, a nitrogen introducing tube and a dropping funnel, 74.5 g (600 mmol) of methylthiobenzene and 480 ml of dichloromethane were placed and cooled down to 10° C. in an ice bath, and then 80 g (600 mmol) of aluminum chloride was added. Then, 125.7 g (600 mmol) of 2,5-dichlorobenzoyl chloride was slowly dropped from the dropping funnel. On completion of dropping, 80 g (600 mmol) of aluminum chloride was further added. Then, the temperature of the reaction mixture was brought back to room temperature, and stirring was continued for 12 hours.

Then, the obtained reaction solution was poured into 2 liters of ice water containing 300 ml of concentrated hydrochloric acid, and the separated organic layer was extracted with a 10% aqueous solution of sodium hydroxide. Then, the sodium hydroxide was neutralized with hydrochloric acid, and the precipitated solid product was extracted with 2 liters of ethyl acetate. The solvent was distilled off, and the obtained solid product was recrystallized with a mixed solvent of ethyl acetate and n-hexane to yield 150 g of 2,5-dichloro-4′-hydrothiobenzophenone (the compound (A₁′-3)) (yield: 88%).

Next, 28.3 g (100 mmol) of 2,5-dichloro-4′-hydrothiobenzophenone as the compound (A₁′-3), 100 g (1200 mmol) of 2H-dihydropyran and 100 ml of toluene were placed in a flask; 1.5 g of a cation exchange resin (Amberlyst-15 (trade name)) was added under stirring, and the reaction mixture thus obtained was stirred for 5 hours at room temperature; then, the cation exchange resin was removed by filtration. Then, the obtained filtrate was washed with an aqueous solution of sodium hydroxide and an aqueous solution of sodium chloride, dried with magnesium sulfate, and then the solvent was distilled off. The obtained solid product was recrystallized with toluene to yield 19.5 g of 2,5-dichloro-4′-(tetrahydro-2-pyranylthio)benzophenone (the compound (A₁-3) )(yield: 53%). The above described steps are shown in the following reaction formula (22).

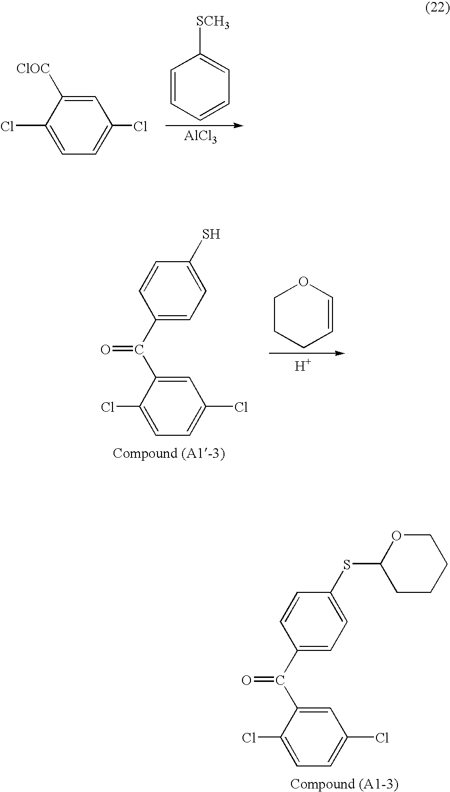

Next, in a 500-ml flask equipped with stirring blades, a thermometer and a nitrogen introducing tube, 16.3 g (44. 4mmol) of 2,5-dichloro-4′-(tetrahydro-2-pyranylthio)benzophenone as the compound (A₁-3), 6.55 g (0.585 mmol) of a 4,4′-dichlorobenzophenone/2,2-bis(4-hydroxyphenyl)-1,1,1,3,3,3-hexafluoropropane polycondensate (the number average molecular weight: 11,200) as the compound (A₂-3), 0.883 g (1.35 mmol) of bis(triphenylphosphine)nickel dichloride, 0.877 g (5.85 mmol) of sodium iodide, 4.72 g (18 mmol) of triphenylphosphine and 7.06 g (108 mmol) of zinc were placed and vacuum dried. Then, the atmosphere inside the flask was replaced with dry nitrogen, and thereafter 52 ml of DMAc was added, and polymerization was carried out under controlling the temperature of the reaction solution so as to fall within a range from 70 to 90° C. After 3 hours, the reaction solution was diluted by adding 200 ml of DMAc, the insoluble matter was removed by filtration to yield a polymer filtrate solution. It is inferred that this polymer filtrate solution contained the compound (A′-3), and the compound (A′-3) had tetrahydro-2-pyranyl groups. Then, the polymer filtrate solution was poured into 1.5 liters of methanol containing 10 vol % of concentrated hydrochloric acid to precipitate the polymer. Then, the precipitate was separated by filtration, and thereafter the obtained solid product was dried to yield 15.2 g of the polymer having thiol groups (the compound (A-3)). The above described steps are shown in the following reaction formula (23). In the reaction formula (23), d, e and f are positive integers.

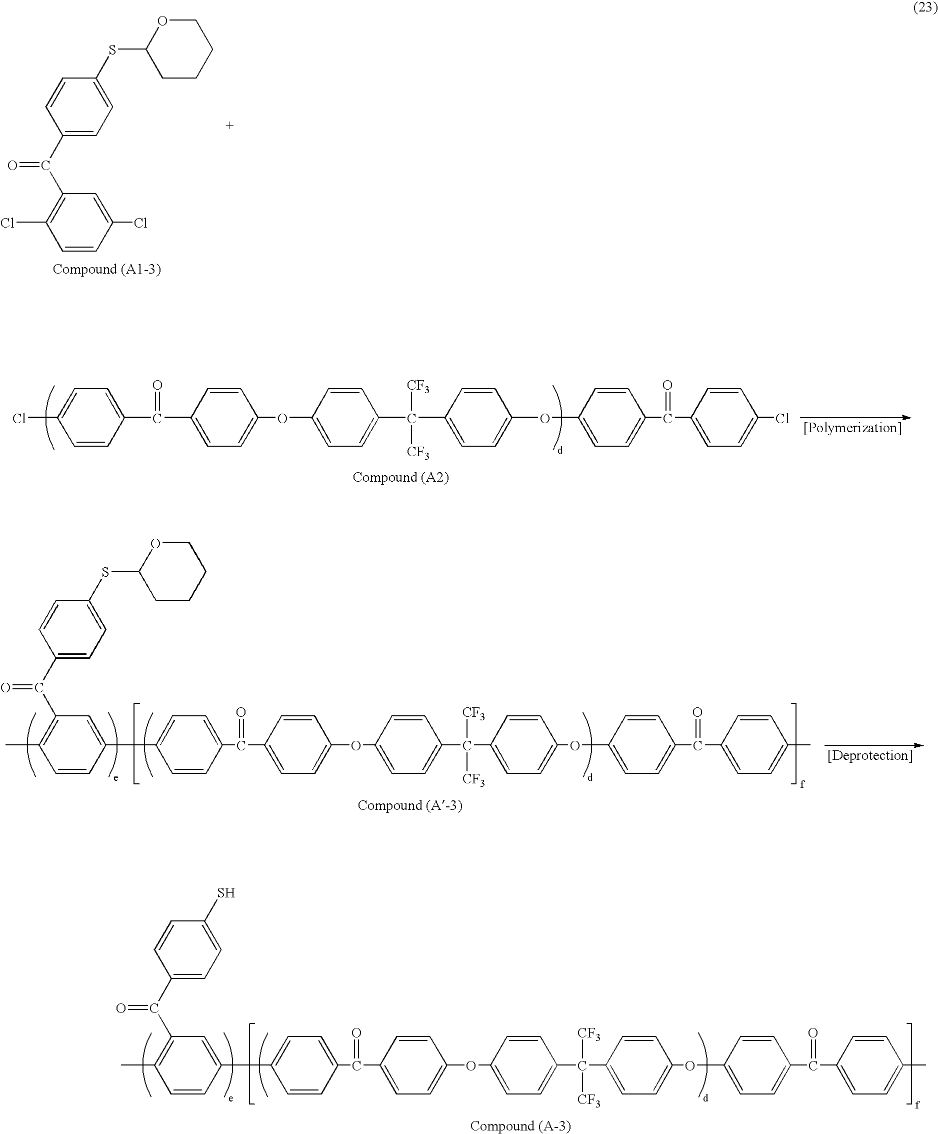

Next, 15.2 g of the compound (A-3) was added to 250 ml of DMAc, and dissolved by stirring under heating to 100° C. Then, 1.06 g (133 mmol) of lithium hydride was added to the reaction solution, and the reaction solution was stirred for 2 hours. Successively, 16.2 g (133 mmol) of propanesultone as the compound (B-1) was added to the reaction solution, and the reaction was allowed to proceed for 8 hours. Then, the insoluble matter of the obtained reaction solution was removed by filtration, and the filtrate was poured into 1 M hydrochloric acid to precipitate the polymer. The precipitated polymer was washed with 1 M hydrochloric acid, and thereafter was washed with distilled water until the wash water became neutral. The polymer was dried at 75° C. to yield 19.9 g of a polyarylene copolymer (the compound (4)) having sulfonic acid groups as a powdery polymer. The above described steps are shown in the following reaction formula (24). In the reaction formula (24), d, e and f are positive integers.

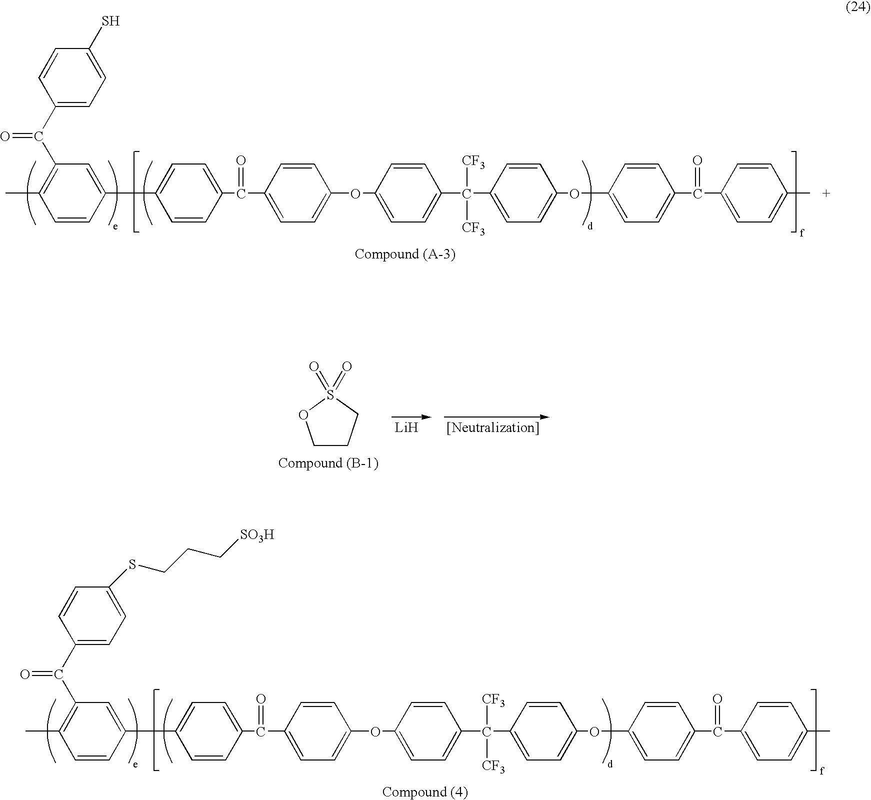

Next, a membrane-electrode assembly was fabricated in the same manner as in Example 1 except that the polyarylene copolymer (compound (4)) obtained in the present example was used.

Next, the physical properties of the polyarylene copolymer, the solid polymer electrolyte membrane, and the membrane-electrode assembly obtained in the present example were evaluated in the same manner as in Example 1. The results obtained are shown in Table 1.

### COMPARATIVE EXAMPLE 1

In the present comparative example, polyether ether ketone (PEEK) was treated with concentrated sulfuric acid to yield a sulfonated polyether ether ketone.

Next, a membrane-electrode assembly was fabricated in the same manner as in Example 1 except that the sulfonated polyether ether ketone obtained in the present comparative example was used.

Next, the physical properties of the sulfonated polyether ether ketone, the solid polymer electrolyte membrane, and the membrane-electrode assembly obtained in the present comparative example were evaluated in the same manner as in Example 1. The results obtained are shown in Table 1.

TABLE 1

| | | | | | Comp. |
|---|---|---|---|---|---|
| | Ex. 1 | Ex. 2 | Ex. 3 | Ex. 4 | ex. 1 |
| Ion-exchange capacity | 1.9 | 2.0 | 2.0 | 1.9 | 1.5 |
| (meq/g) | | | | | |
| Proton conductivity | 0.27 | 0.25 | 0.28 | 0.22 | 0.03 |
| (S/cm) | | | | | |
| Hot-water resistance (%) | 100 | 100 | 100 | 100 | 65 |
| Thermal decomposition | 200 | 200 | 200 | 240 | 250 |
| initiation temperature | | | | | |
| (° C.) | | | | | |
| Resistance to Fenton's | 100 | 100 | 100 | 100 | 0 |
| reagent (%) | | | | | |
| Electric power generation | 0.620 | 0.620 | 0.625 | 0.618 | — |
| performance (V) | | | | | |

As can be seen clearly from Table 1, the polyarylene copolymers having sulfonic acid groups obtained in the individual examples each has a large ion-exchange capacity owing to the aliphatic sulfonic acid groups contained therein, and the solid polymer electrolyte membranes formed of the polyarylene copolymers each have an excellent proton conductivity.

As can also be seen from Table 1, the polyarylene copolymers having sulfonic acid groups obtained in the individual examples each have the sulfonic acid groups at positions separated away from the main chain, are therefore excellent in hot-water resistance and oxidation resistance as demonstrated by the resistance to Fenton's reagent, and the membrane-electrode assemblies comprising the solid polymer electrolyte membranes formed of the polyarylene copolymers each have an excellent electric power generation performance.

What is claimed is:

1. A membrane-electrode assembly for a solid polymer electrolyte fuel cell, comprising a solid polymer electrolyte membrane sandwiched between a pair of electrodes each containing a catalyst, wherein:
said solid polymer electrolyte membrane is formed of a polyarylene polymer comprising a repeating unit represented by the following general formula (1); and
said electrodes each comprises catalyst particles with platinum or a platinum alloy supported thereon in a percentage loading range from 20 to 80 mass % in relation to the total mass of said catalyst, and an ion conductive binder in a mass range from 0.1 to 3.0 times the mass of said catalyst particles: 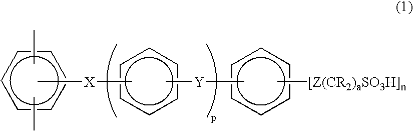
wherein X and Y each represents a divalent organic group or forms together a direct bond; Z represents an oxygen atom or a sulfur atom; R represents at least one atom or group selected from the group consisting of a hydrogen atom, a fluorine atom, an alkyl group and a fluorine-substituted alkyl group; a represents an integer of 1 to 20; n represents an integer of 1 to 5; and p represents an integer of 0 to 10.

2. The membrane-electrode assembly for a solid polymer electrolyte fuel cell according to claim 1, wherein said solid polymer electrolyte membrane is formed of a polyarylene copolymer comprising a first repeating unit represented by said general formula (1) and a second repeating unit represented by the following general formula (2): 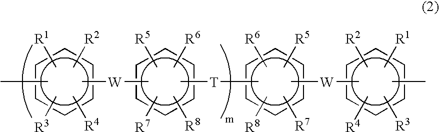
wherein R¹ to R⁸ may be the same or different from each other, and each represents at least one atom or group selected from the group consisting of a hydrogen atom, a fluorine atom, an alkyl group, a fluorine-substituted alkyl group, an allyl group and an aryl group; W represents a divalent electron-withdrawing group; T represents a divalent organic group; and m represents 0 or a positive integer.

3. The membrane-electrode assembly for a solid polymer electrolyte fuel cell according to claim 1, wherein said polyarylene polymer has a weight average molecular weight falling within a range from 10,000 to 1,000,000 relative to polystyrene standards as measured by gel permeation chromatography.

4. The membrane-electrode assembly for a solid polymer electrolyte fuel cell according to claim 1, wherein said polyarylene polymer comprises sulfonic acid groups in an amount falling within a range from 0.5 to 3 meq/g.

5. The membrane-electrode assembly for a solid polymer electrolyte fuel cell according to claim 1, wherein said polyarylene polymer is one compound selected from the group consisting of the compounds 1 to 4 represented by the following formulas: 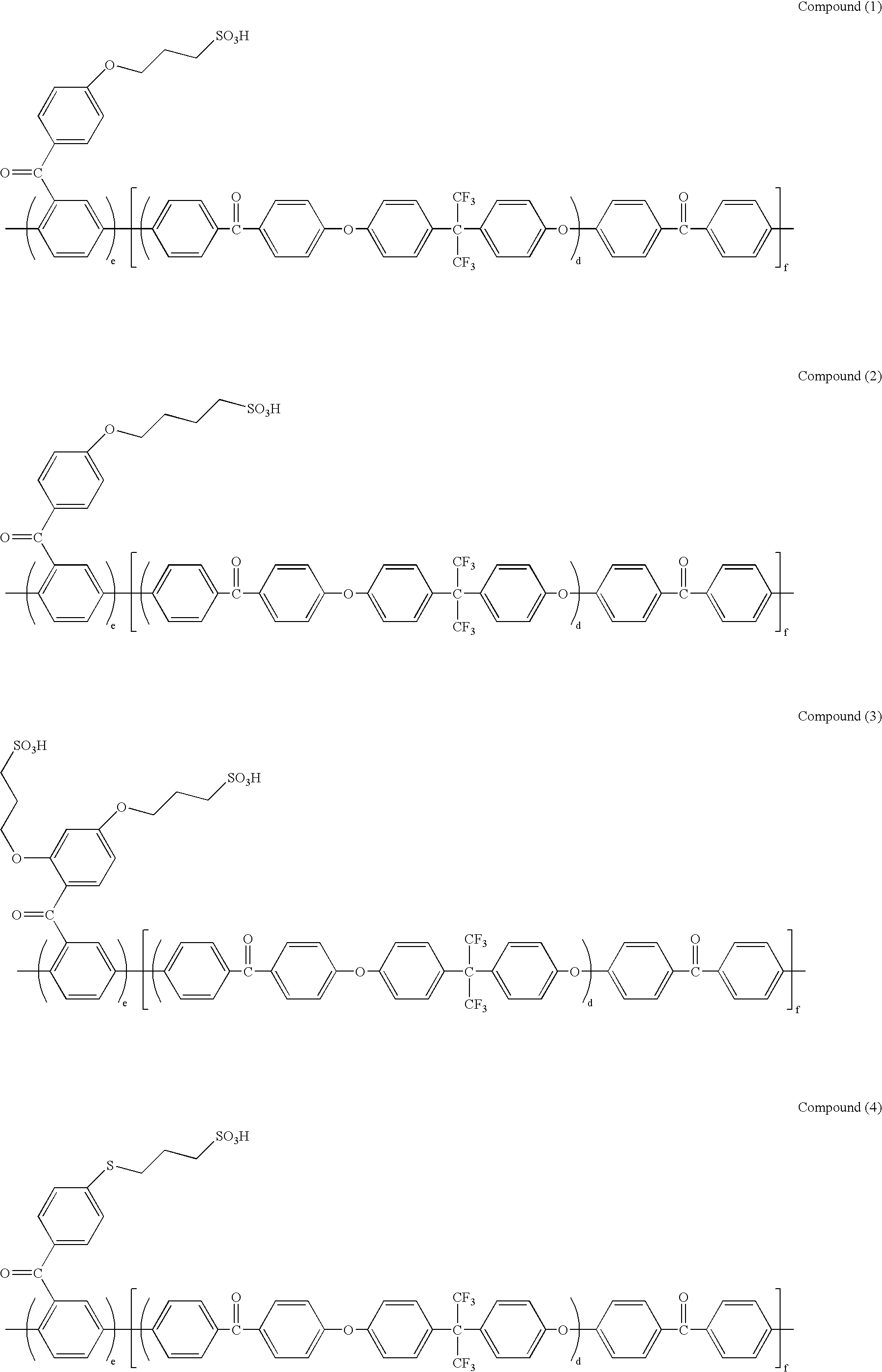
wherein d, e and f in the respective formulas are positive integers.

6. A solid polymer electrolyte fuel cell comprising a membrane-electrode assembly for a solid polymer electrolyte fuel cell, wherein:
a solid polymer electrolyte membrane formed of a polyarylene polymer comprising a repeating unit represented by the following general formula (1) is sandwiched between a pair of electrodes each comprising catalyst particles with platinum or a platinum alloy supported thereon in a percentage loading range from 20 to 80 mass % in relation to the total mass of the catalyst, and an ion conductive binder in a mass range from 0.1 to 3.0 times the mass of said catalyst particles: 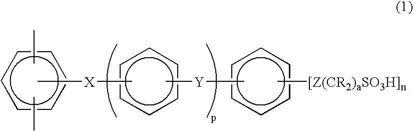
wherein X and Y each represents a divalent organic group or forms together a direct bond; Z represents an oxygen atom or a sulfur atom; R represents at least one atom or group selected from the group consisting of a hydrogen atom, a fluorine atom, an alkyl group and a fluorine-substituted alkyl group; a represents an integer of 1 to 20; n represents an integer of 1 to 5; and p represents an integer of 0 to 10.

7. The solid polymer electrolyte fuel cell according to claim 6, wherein said solid polymer electrolyte membrane is formed of a polyarylene copolymer comprising a first repeating unit represented by said general formula (1) and a second repeating unit represented by the following general formula (2): 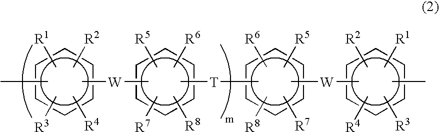
wherein R¹ to R⁸ may be the same or different from each other, and each represents at least one atom or group selected from the group consisting of a hydrogen atom, a fluorine atom, an alkyl group, a fluorine-substituted alkyl group, an allyl group and an aryl group; W represents a divalent electron-withdrawing group; T represents a divalent organic group; and m represents 0 or a positive integer.

8. The solid polymer electrolyte fuel cell according to claim 6, wherein said polyarylene polymer has a weight average molecular weight falling within a range from 10,000 to 1,000,000 relative to polystyrene standards as measured by gel permeation chromatography.

9. A membrane-electrode assembly for a solid polymer electrolyte fuel cell according to claim 1, wherein said polyarylene polymer comprises sulfonic acid groups in an amount falling within a range from 0.5 to 3 meq/g.

10. The solid polymer electrolyte fuel cell according to claim 6, wherein said polyarylene polymer is one compound selected from the group consisting of the compounds 1 to 4 represented by the following formulas: 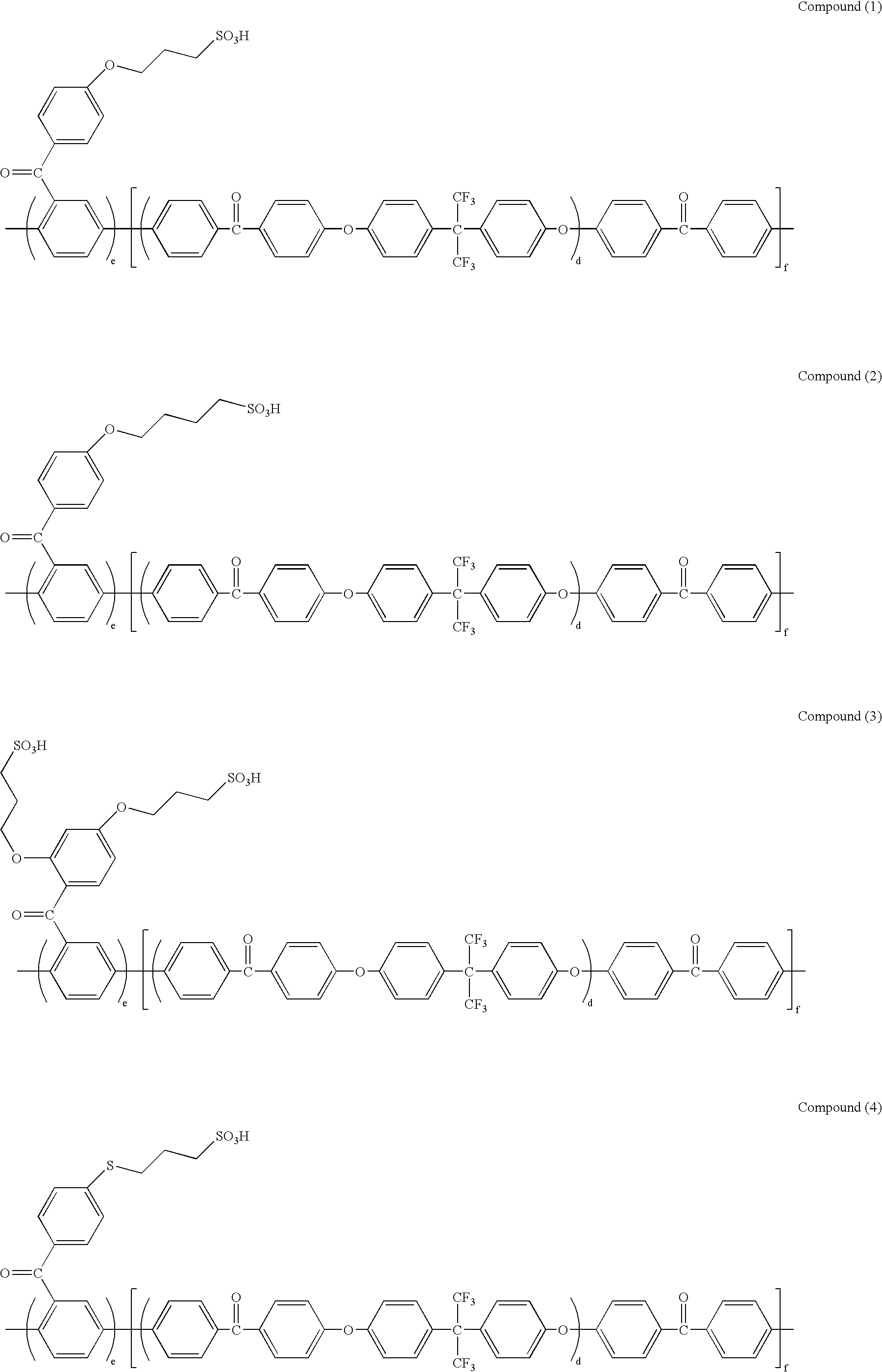
wherein d, e and f in the respective formulas are positive integers.
